(19) United States
(12) Patent Application Publication
(10) Pub. No.: US 2024/0354034 A1
(43) Pub. Date: Oct. 24, 2024

(54) INSPECTION APPARATUS THAT INSPECTS IMAGE FORMED BY IMAGE FORMING APPARATUS, AND METHOD FOR CONTROLLING IMAGE FORMING SYSTEM

(71) Applicant: CANON KABUSHIKI KAISHA, Tokyo (JP)

(72) Inventor: RYOSUKE YAMAZAKI, Tokyo (JP)

(21) Appl. No.: 18/633,669

(22) Filed: Apr. 12, 2024

(30) Foreign Application Priority Data
Apr. 24, 2023 (JP) 2023-070970

(51) Int. Cl. G06F 3/12; G06T 7/00

(52) U.S. Cl. CPC G06F 3/1208; G06F 3/1256; G06T 7/001; G06T 2207/30144

(57) ABSTRACT

An inspection apparatus accepts user selection information indicating an inspection level for an inspection item to be inspected in an image read by an image sensor, obtains an adjustment setting pertaining to a frequency of executing adjustment processing in which an image forming apparatus forms an adjustment image, wherein based on a result of detecting the adjustment image, the image forming apparatus adjusts a quality of an image, executes inspection at the inspection level indicated by the user selection information upon a first adjustment setting being obtained, and executes inspection at an inspection level lower than or equal to a predetermined inspection level, and not executes inspection at an inspection level higher than the predetermined inspection level, in a case a second adjustment setting in which the frequency is lower than in the first adjustment setting is obtained.

### BACKGROUND OF THE INVENTION

### Field of the Invention

The present invention relates to an inspection apparatus that inspects an image formed by an image forming apparatus, and a method for controlling an image forming system comprising the inspection apparatus that inspects the image formed by the image forming apparatus.

### Description of the Related Art

An inspection apparatus can perform an inspection while conveying a sheet on which an image has been formed by an image forming apparatus. For example, an image formed on a sheet is inspected for misalignment, black spots, or streak images. Japanese Patent Laid-Open No. 2022-170678 describes a user setting an inspection level indicating the strictness of an inspection.

Incidentally, the printing capabilities of an image forming apparatus gradually decrease according as more images are formed on sheets. Accordingly, when a specific execution condition is satisfied, the image forming apparatus executes adjustment processing (calibration) to maintain its own printing capabilities. The execution frequency of the adjustment processing may be determined by an operator (a user). Specifically, the user determines that the adjustment processing is to be executed each time images have been formed on a predetermined number of sheets. For example, the quality of the output of the image forming apparatus when the adjustment processing is executed each time images have been formed on 100 sheets is better than the quality of the output of the image forming apparatus when the adjustment processing is executed each time images have been formed on 1,000 sheets.

In a configuration in which the user can freely set the inspection level, such as in Japanese Patent Laid-Open No. 2022-170678, the number of sheets determined to have failed may increase depending on the execution frequency of the adjustment processing.

### SUMMARY OF THE INVENTION

The present disclosure provides an inspection apparatus that inspects an image formed on a sheet by an image forming apparatus. The inspection apparatus may comprise the followings. An image sensor is configured to read the image on the sheet. A controller is configured to accept user selection information indicating an inspection level for an inspection item to be inspected in the image read by the image sensor, obtain an adjustment setting pertaining to a frequency of executing adjustment processing in which the image forming apparatus forms an adjustment image, wherein based on a result of detecting the adjustment image, the image forming apparatus adjusts a quality of an image formed by the image forming apparatus, execute inspection at the inspection level indicated by the user selection information, in a case where a first adjustment setting is obtained, and execute inspection at an inspection level lower than or equal to a predetermined inspection level, and not execute inspection at an inspection level higher than the predetermined inspection level, in a case where a second adjustment setting in which the frequency is lower than in the first adjustment setting is obtained.

Further features of the present invention will become apparent from the following description of exemplary embodiments (with reference to the attached drawings).

### BRIEF DESCRIPTION OF THE DRAWINGS

FIG. 1 is a diagram illustrating an image forming system.

FIG. 2 is a diagram illustrating a control apparatus.

FIG. 3 is a diagram illustrating an inspection controller.

FIG. 4 is a diagram illustrating a stacking controller.

FIG. 5 is a diagram illustrating a host computer.

FIG. 6 is a diagram illustrating a print settings screen.

FIG. 7 is a diagram illustrating an inspection settings screen.

FIGS. 8A and 8B are diagrams illustrating a user interface for setting an inspection level.

FIG. 9 is a diagram illustrating a test image.

FIG. 10 is a diagram illustrating a test image.

FIGS. 11A to 11F are diagrams illustrating adjustment settings.

FIG. 12 is a diagram illustrating a determination table.

FIG. 13 is a flowchart illustrating inspection settings.

FIG. 14 is a flowchart illustrating a method for determining an upper limit value for an inspection level.

FIG. 15 is a flowchart illustrating a method for executing a job in the control apparatus.

FIG. 16 is a flowchart illustrating a method for executing a job in the inspection apparatus.

FIG. 17 is a flowchart illustrating a method for executing a job in a stacking apparatus.

FIG. 18 is a diagram illustrating a controller of an image forming apparatus.

FIG. 19 is a diagram illustrating a screen that indicates detailed information on an inspection level that is unselectable.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

### (1) Image Forming System

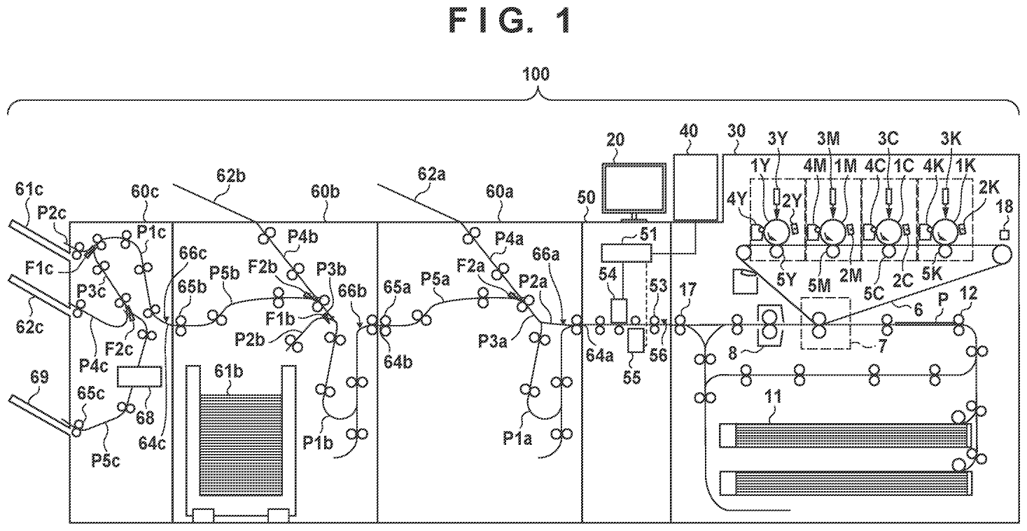

As illustrated in FIG. 1, an image forming system 100 includes an operation unit 20, an image forming apparatus 30, a control apparatus 40, an inspection apparatus 50, and stacking apparatuses 60a, 60b, and 60c. The image forming apparatus 30, the inspection apparatus 50, and the stacking apparatuses 60a, 60b, and 60c have separate housings. It is sufficient for the number of the stacking apparatuses 60 to be at least one. The image forming system 100 may be called an “image inspection system”. In this example, the stacking apparatuses 60a and 60b may be called “sheet stackers” or “sheet conveyance apparatuses”. The stacking apparatus 60c may be called a “post-processing apparatus” or “finisher” having functions for post-processing. Multiple constituent elements that are the same or similar are given the same reference signs. The lowercase letters at the ends may be omitted when describing matters which are common to all items.

The operation unit 20 includes a display device that outputs information to a user and an input device that accepts instructions from the user (e.g., a touch panel sensor). The operation unit 20 may be provided in the housing of the image forming system 100, or may be attached to the exterior of the housing of the image forming system 100. The image forming apparatus 30 forms a toner image on a sheet P in accordance with Y, M, C, and K color signals supplied from the control apparatus 40. The letters Y, M, C, and K appended to the reference signs indicate the toner colors yellow, magenta, cyan, and black. When matters common to all four colors are described, the letters Y, M, C, and K will be omitted from the reference signs.

A photosensitive member 1 is an image carrier that carries an electrostatic latent image and a toner image. A charger 2 (2Y, 2M, 2C, and 2K) uniformly charges the surface of the photosensitive member 1. An exposure device 3 forms an electrostatic latent image by irradiating the photosensitive member 1 with a laser beam according to the color signal supplied from the control apparatus 40. A developer 4 uses toner to develop the electrostatic latent image and forms a toner image. A primary transfer roller 5Y transfers the toner image from the photosensitive member 1 to an intermediate transfer belt 6. Here, Y, M, C, and K toner images are superimposed to form a color image. The intermediate transfer belt 6 conveys the toner image to a secondary transfer section 7. A light sensor 18 detects a test image formed on the intermediate transfer belt 6. The result of detecting the test image is used in image forming condition adjustment processing. The printing capabilities of the image forming apparatus 30 are maintained when the image forming conditions are adjusted properly.

A sheet cassette 11 is a holding unit that holds a large number of sheets P. A conveyance roller 12 feeds a sheet P contained in the sheet cassette 11 and conveys the sheet P along a conveyance path.

The secondary transfer section 7 transfers the toner image from the intermediate transfer belt 6 to the sheet P. A fixer 8 fixes the toner image onto the sheet P by applying heat and pressure to the sheet P and the toner image. A discharge roller 17 discharges the sheet P to the inspection apparatus 50.

The inspection apparatus 50, implemented as a reading apparatus, is an apparatus that reads an image formed on a sheet P and inspects the quality of the image. In other words, the inspection apparatus 50 is an apparatus that inspects whether the image formed on the sheet P satisfies an inspection standard. The sheet P on which the image is formed is sometimes called a “printed product” (a “deliverable”).

The image on the sheet P being conveyed by conveyance rollers 53 is read at a reading position by image sensors 54 and 55. The image sensors 54 and 55 include a light source that illuminates the sheet P and a CMOS sensor. “CMOS” is an acronym for “Complementary Metal Oxide Film Semiconductor”. The image sensors 54 and 55 may be called “cameras” or “image capturing devices”.

The sheet P from which the image has been read is discharged to the stacking apparatuses 60. Note that for a sheet P which is determined to be a “no good” (i.e., does not satisfy the inspection standard; this may also be called “failing”) by the inspection apparatus 50, the control apparatus 40 controls the image forming apparatus 30 to form the same image on a new sheet P. An inlet of the inspection apparatus 50 is provided with a sheet sensor 56 that detects the sheet P.

The stacking apparatus 60a receives the sheet P discharged from the inspection apparatus 50 through an inlet 64a, and discharges the sheet P to a sheet tray 62a serving as a stacking unit, discharges the sheet P from an outlet 65a, or the like. A sheet sensor 66a that detects the sheet P is provided at the inlet 64a.

A branch between a conveyance path P1a and a conveyance path P2a is located downstream from the inlet 64a. A flapper (not shown) is disposed at the branch, and guides the sheet P to either the conveyance path P1a or the conveyance path P2a. The conveyance paths P1a and P2a are each connected to a conveyance path P3a.

The conveyance path P3a branches to a conveyance path P4a and a conveyance path P5a at a branch position where a flapper F2a is installed. The sheet P that has been conveyed by the conveyance path P3a is guided to the conveyance path P4a or the conveyance path P5a by the flapper F2a.

The sheet tray 62a is provided at an outlet of the conveyance path P4a. For example, a sheet P having an image quality determined to have failed by the inspection apparatus 50 may be stacked on the sheet tray 62a. However, a sheet P having an image quality determined to have failed may be discharged to an apparatus in the later stage from the outlet 65a. A sheet P determined to be “OK” (i.e., satisfies the inspection standard; this may also be called “passing”) may be stacked onto (discharged to) the sheet tray 62a. The conveyance path P5a extends to the outlet 65a.

The stacking apparatus 60b receives the sheet P discharged from the stacking apparatus 60a through an inlet 64b, and stacks (discharges) the sheet P onto sheet trays 61b and 62b serving as stacking units, discharges the sheet P from an outlet 65b, or the like. A sheet sensor 66b that detects the sheet P is provided at the inlet 64b.

A conveyance path P1b extending from the inlet 64b branches to a conveyance path P2b and a conveyance path P3b at a branch position where a flapper F1b is installed. The sheet P that has been conveyed through the conveyance path P1b is guided to the conveyance path P2b or the conveyance path P3b by the flapper Fib. A sheet tray 61b is provided at an outlet of the conveyance path P2b. The sheet tray 61b is a large-capacity sheet stacking tray on which a large number of sheets P can be stacked. For example, a sheet P which has passed the image inspection (quality inspection) may be stacked on the sheet tray 61b.

The conveyance path P3b branches to a conveyance path P4b and a conveyance path P5b at a branch position where a flapper F2b is installed. The sheet P that has been conveyed through the conveyance path P3b is guided to the conveyance path P4b or the conveyance path P5b by the flapper F2b.

A sheet tray 62b is provided at an outlet of the conveyance path P4b. For example, a sheet P having an image quality determined to have failed by the inspection apparatus 50 may be stacked on the sheet tray 62b. However, a sheet P having an image quality determined to have failed may be discharged to an apparatus in the later stage from the outlet 65b. A sheet P determined to be “OK” (i.e., satisfies the inspection standard; this may also be called “passing”) may be stacked onto the sheet tray 62b. The conveyance path P5b extends to the outlet 65b.

The stacking apparatus 60c receives the sheet P discharged from the outlet 65b through an inlet 64c. A sheet sensor 66c that detects the sheet P is provided at the inlet 64c. An apparatus in a later stage may be connected to the outlet 65b. A conveyance path Plc extending from the inlet 64c branches to a conveyance path P2c and a conveyance path P3c at a branch position where a flapper F1c is installed. A sheet tray 61c is provided at an outlet of the conveyance path P2c. The conveyance path P3c branches to a conveyance path P4c and a conveyance path P5c at a branch position where a flapper F2c is installed. A sheet tray 62c is provided at an outlet of the conveyance path P4c. The conveyance path P5c extends to an outlet 65c. A sheet tray 69 is provided at the outlet 65c of the conveyance path P5c. The sheet tray 69 can also stack sheets P for which the image quality is determined to have failed and sheets P for which the image quality is determined to have passed. For example, a sheet P having an image quality determined to have failed by the inspection apparatus 50 may be stacked on the sheet tray 61c (or 62c or 69). In this manner, the type of the sheet P discharged to the sheet trays 61b, 61c, 62a, 62b, 62c, and 69 is determined in advance based on settings made by the user.

The sheet trays 61c, 62c, and 69 provided in the stacking apparatus 60c may be called an upper tray, a middle tray, and a lower tray, respectively. A post-processing unit 68 may include a stapling processor that bundles the sheets P discharged from the stacking apparatus 60b to form a sheet bundle and staples the sheet bundle. The post-processing unit 68 may include a binding processor that folds sheet bundle in half. The post-processing unit 68 may include a cutting processor that cuts a sheet bundle.

Each of the conveyance paths P1, P2, P3, P4, and P5 is provided with one or more conveyance rollers 63. The conveyance rollers 63 convey the sheet P from the upstream side to the downstream side in a conveyance direction of the sheet P. The conveyance rollers 63 may be roller pairs each including two rollers that convey the sheet P with the sheet P located therebetween.

Note that it is sufficient for the number of stacking apparatuses 60 connected to the downstream side of the inspection apparatus 50 to be at least one. In addition, it is sufficient for the number of sheet trays 61, 62, and 69 provided in the stacking apparatus 60 connected to the downstream side of the inspection apparatus 50 to be at least two total in the image forming system 100. In addition, it is sufficient for the number of flappers F1 and F2 to be at least one.

Note that a conveyance path from the reading position where the image sensor 54 reads the image on the sheet (or where the image sensor 55 reads the image on the sheet) to a branch position of the flapper F2c may be called a “main path”. The conveyance path P4a that branches from the main path at the branch position of the flapper F2a may also be called a “branch path”. Likewise, the conveyance path P2b that branches from the main path at the branch position of the flapper Fib may also be called a “branch path”. Furthermore, the conveyance path P4b that branches from the main path at the branch position of the flapper F2b may also be called a “branch path”. Further still, a conveyance path P2c that branches from the main path at the branch position of a flapper F1c may also be called a “branch path”. Finally, the conveyance path P4c that branches from the main path at the branch position of the flapper F2c may also be called a “branch path”. In the stacking apparatus 60a illustrated in FIG. 1, the path from the reading position through the conveyance path P1a corresponds to the main path. In other words, the first branch path that branches from the main path corresponds to the conveyance path P4a. Each conveyance path functions as a conveyance path that guides the sheets.

### (2) Controller

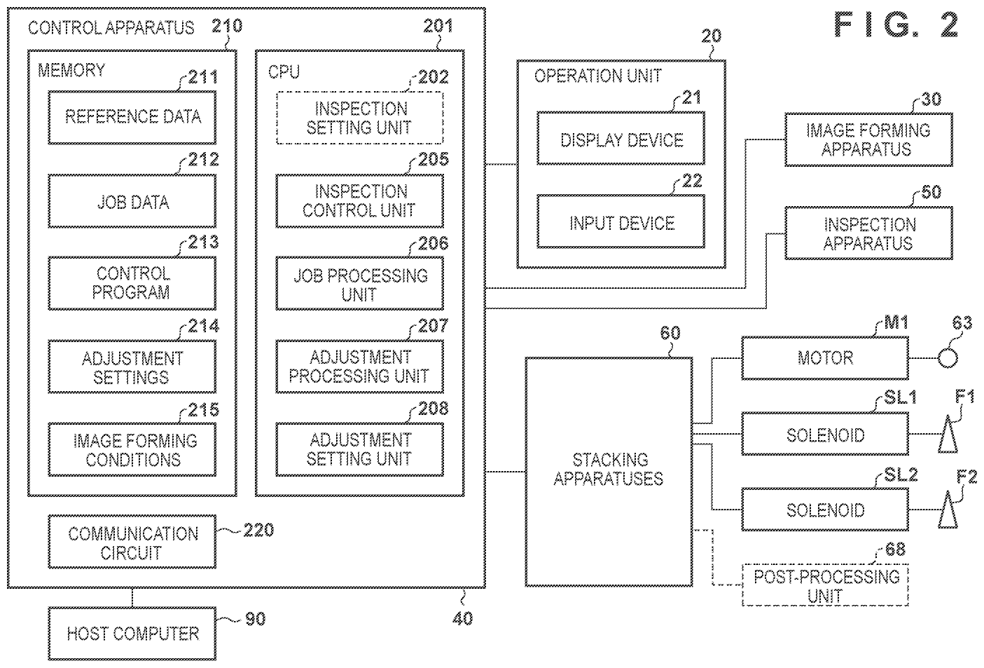

FIG. 2 illustrates the control apparatus 40 in detail. The control apparatus 40 may be provided within the housing of the image forming apparatus 30, or may be provided outside the housing of the image forming apparatus 30. A CPU 201 is a central processing unit that implements a plurality of functions by executing a control program 213 stored in a memory 210. The CPU 201 may include a plurality of processors or CPU cores. Some or all of the plurality of functions implemented by the CPU 201 may be implemented by hardware circuitry different from the CPU 201. The memory 210 is a storage device including a read-only memory (ROM), a random access memory (RAM), a solid-state drive (SSD), a hard disk drive (HDD), and the like. A communication circuit 220 includes a network interface that connects to a local area network, and a communication interface that communicates with the image forming apparatus 30, the inspection apparatus 50, the stacking apparatuses 60, and a host computer 90. The CPU 201 communicates with the image forming apparatus 30, the inspection apparatus 50, and the stacking apparatuses 60 through the communication circuit 220. The operation unit 20 includes a display device 21 and an input device 22. The operation unit 20 may include an audio circuit and a speaker that output messages to a user. The CPU 201 functions as an inspection setting unit 202, an inspection control unit 205, and a job processing unit 206 in accordance with the control program 213.

The inspection setting unit 202 displays an inspection settings screen and a job input screen in the display device 21 provided in the operation unit 20. The inspection setting unit 202 may be provided in the host computer 90. The inspection setting unit 202 accepts setting instructions, job execution instructions, and the like from the user through the input device 22 provided in the operation unit 20. The inspection setting unit 202 accepts settings for the discharge destination of the sheet P, inspection content (misalignment, color shift, tint variations, streak images, black spots, and the like), and inspection level settings, for example. The inspection content may be called “inspection items”. The sheets P may have different discharge destinations depending on whether the sheets P have passed the inspection or failed the inspection. The inspection level indicates the strictness of the image inspection. For example, as the numerical value indicating the inspection level increases, a higher printing accuracy is required. In other words, as the numerical value of the inspection level increases, a determination threshold (described later) decreases. However, a higher printing accuracy may be required as the numerical value indicating the inspection level decreases instead. The inspection setting unit 202 stores settings data, which is information pertaining to image inspection, such as the discharge destination, inspection content, inspection level, and the like set by the user through the display device 21, in the memory 210. The following will describe the settings data as being included in job data 212, but settings data independent from the job data 212 may be present instead.

The memory 210 further stores reference data 211, adjustment settings 214, and image forming conditions 215. The reference data 211 is comparison data used as passing criteria in the image inspection. The reference data 211 may be, for example, document image data (RIP image data) associated with a print job (the job data 212) received from the host computer 90. “RIP” is an acronym for “Raster Image Processing”. The reference data 211 may be image data obtained by, for example, reading one or more sheets on which an image corresponding to a reference image is formed.

An adjustment processing unit 207 is used to adjust the image forming conditions 215 used by the image forming apparatus 30. The image forming conditions 215 can include, for example, image writing timings (in a main scanning direction and a sub scanning direction) for each of the Y, M, C, and K colors, an exposure amount of the exposure device 3, a charging bias, a development bias, a lookup table for tone correction, and the like. The image forming conditions 215 are adjusted based on a result of detecting a test image according to an adjustment target.

The adjustment settings 214 include enabling/disabling adjustment processing, an execution frequency of the adjustment processing (an execution interval), and the like. An adjustment setting unit 208 displays a settings screen in the display device 21, and accepts the input of the adjustment settings 214 through the input device 22.

The inspection control unit 205 controls the inspection apparatus 50 based on the settings data included in the job data 212. For example, when the reference data 211 is requested by the inspection apparatus 50 through the communication circuit 220, the inspection control unit 205 sends the reference data 211 to the inspection apparatus 50. The inspection control unit 205 obtains information on the result of the image inspection from the inspection apparatus 50 serving as an inspection unit, through the communication circuit 220. Based on the inspection result, the inspection control unit 205 controls the flappers F1 and F2 to discharge the sheet P into the sheet tray, among the sheet trays 61, 62, and 69, which has been designated by the user.

The job processing unit 206 controls print jobs for printing images onto the sheets P, stacking jobs for stacking sheet bundles in the stacking apparatuses 60a and 60b, post-processing jobs for stacking sheet bundles in the stacking apparatus 60c, and the like. The job processing unit 206 holds the job data 212 required to execute the jobs in the memory 210.

The stacking apparatuses 60 drive a motor M1 to rotate the conveyance rollers 63 in accordance with control commands from the job processing unit 206. The stacking apparatuses 60 drive solenoids SL1 and SL2 to switch the flappers F1 and F2 in accordance with control commands from the job processing unit 206. As a result, the sheet P is guided and conveyed to either the sheet tray 61, the sheet tray 62, or the stacking apparatus 60c. For example, if the result of the image inspection by the inspection apparatus 50 is “no good” (fail), the job processing unit 206 controls the stacking apparatuses 60 to discharge the sheet P determined to have failed to the sheet tray 62. The image forming apparatus 30 also includes a solenoid that drives flappers and a motor that drives conveyance rollers, but these are not shown.

### (3) Inspection Apparatus

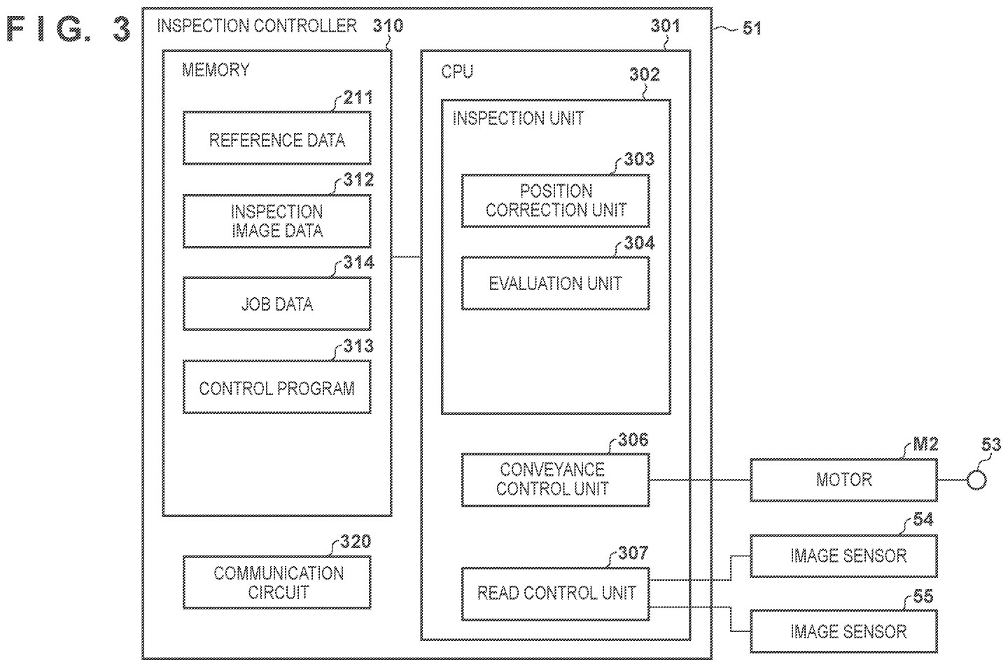

FIG. 3 illustrates an inspection controller 51 provided in the inspection apparatus 50 in detail. A CPU 301 implements a plurality of functions by executing a control program 313 stored in a memory 310. Some or all of the plurality of functions may be implemented by hardware circuitry different from the CPU 301. The memory 310 is a storage device including a ROM, a RAM, an SSD, an HDD, and the like. The CPU 301 is connected to the control apparatus 40 through a communication circuit 320, and receives various types of commands and data, sends inspection results, and the like.

An inspection unit 302 executes image inspection according to job data 314 (including settings data) received from the control apparatus 40 through the communication circuit 320, and sends an image inspection result to the control apparatus 40. Note that the CPU 201 may execute the inspection, or the host computer 90 connected to the image forming system 100 may execute the inspection. In these cases, the CPU 301 sends inspection image data 312 to the CPU 201 or the host computer 90.

A position correction unit 303 performs position correction on reading results from the image sensors 54 and 55. If the sheet P is read by the image sensors 54 and 55 while the sheet P is slanted, the sheet P may be slanted in the read image. The leading end of the sheet P may also deviate from an ideal position in the read image. The position correction unit 303 therefore corrects the position of the sheet P in the reading result by rotating the reading result, shifting coordinates, and the like.

The reference data 211 is comparison data used in the inspection of the image quality. The inspection image data (read image data) 312 is image data generated by the image sensors 54 and 55 reading the sheet P.

An evaluation unit 304 compares the reference data 211 with the inspection image data 312 and determines whether the image formed on the sheet P satisfies the inspection standard. For example, if the inspection content is “misalignment detection”, the evaluation unit 304 may determine that the inspection is passed if the amount of misalignment between the position of the image in the reference data 211 and the position of the image in the inspection image data 312 is no greater than a predetermined value. The evaluation unit 304 may determine that the inspection has failed if the amount of misalignment exceeds the predetermined value. In other words, the amount of misalignment between the position of the image in the reference data 211 and the position of the image in the inspection image data 312 being no greater than the predetermined value corresponds to the inspection standard being satisfied. Meanwhile, the amount of misalignment between the position of the image in the reference data 211 and the position of the image in the inspection image data 312 being greater than the predetermined value corresponds to the inspection standard not being satisfied.

If the inspection content is set to “black spot detection”, the evaluation unit 304 may determine that the inspection is passed if the size of a black spot which is not present in the image in the reference data 211, but which is present in the image in the inspection image data 312, is no greater than a determination threshold. In other words, a black spot corresponds to a noise image which is absent from the image corresponding to the reference data 211, but which is present in an image corresponding to the inspection image data 312 to which reduction processing has been applied. The evaluation unit 304 may determine that the inspection has failed if the size of the black spot exceeds the determination threshold. In other words, the size of the black spot not exceeding the determination threshold corresponds to the inspection standard being satisfied. On the other hand, the size of the black spot exceeding the determination threshold corresponds to the inspection standard not being satisfied.

Although misalignment detection and black spot detection are described in the present embodiment as the inspection content, these are merely examples. For example, streak image detection or the like may be included as the inspection content. “Streak image detection” refers to detecting a streak-shaped image that is not present in the original image. In other words, a streak image corresponds to a noise image which is absent from the image corresponding to the reference data 211, but which is present in an image corresponding to the inspection image data 312 to which reduction processing has been applied. Streak images can occur when it is necessary to clean, replace, or repair a component involved in image formation. In other words, determination processing for determining whether a “streak image” is present may be performed by finding the degree to which the image corresponding to the reference data 211 matches the image corresponding to the inspection image data 312 to which reduction processing (image processing) has been applied.

If the inspection content is “tint detection”, the evaluation unit 304 calculates a tint difference between the image in the reference data 211 and the image in the inspection image data 312. The evaluation unit 304 may determine that the sheet P being inspected has passed if the difference is no greater than a threshold corresponding to the inspection level. The evaluation unit 304 may determine that the sheet P being inspected has failed if the difference exceeds the threshold. In other words, the difference in tint between the image in the reference data 211 and the image in the inspection image data 312 being no greater than the threshold corresponds to the inspection standard being satisfied. On the other hand, the difference in tint between the image in the reference data 211 and the image in the inspection image data 312 being greater than the threshold corresponds to the inspection standard not being satisfied.

In the present embodiment, the relative positions of the image in the reference data 211 and the image in the inspection image data 312 are inspected when the inspection content is “misalignment detection”, but this is merely one example. For example, the absolute position of the image in the inspection image data 312 with respect to an edge of the sheet may be inspected. In this case, if the distance between the absolute position of the image in the reference data 211 and the absolute position of the image in the inspection image data 312 is no greater than the threshold, the inspection is determined to be passed. If the distance exceeds the threshold, the inspection is determined to be failed.

The evaluation unit 304 generates an inspection result indicating the determination result and sends the inspection result to the control apparatus 40 and the stacking apparatuses 60 through the communication circuit 320. The control apparatus 40 discharges sheets P which have failed to the discharge destination designated by the user. The control apparatus 40 controls the image forming apparatus 30 to reprint the images of sheets P that have failed onto other sheets P.

A conveyance control unit 306 drives a motor M2 to rotate the conveyance rollers 53. A reading control unit 307 controls the image sensors 54 and 55 to read the sheet P and generate the inspection image data 312. The image sensor 54 reads a first surface of the sheet P, and the image sensor 55 reads a second surface of the sheet P. This enables images on both sides of the sheet P to be inspected in the present embodiment.

### (4) Stacking Apparatuses

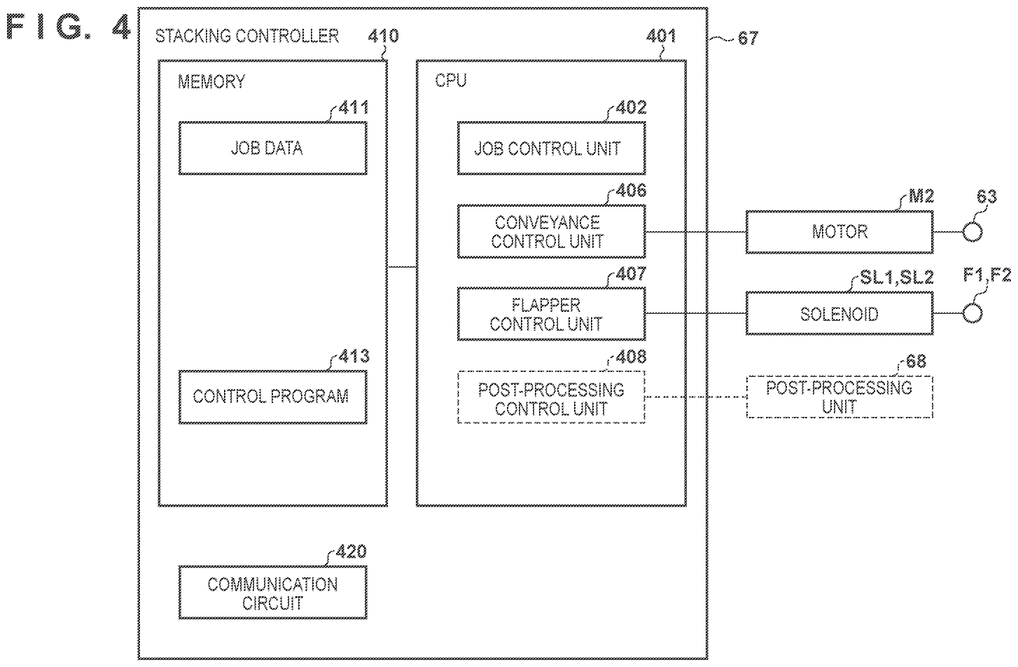

FIG. 4 illustrates a stacking controller 67 provided in each of the stacking apparatuses 60 in detail. A CPU 401 implements a plurality of functions by executing a control program 413 stored in a memory 410. Some or all of the plurality of functions may be implemented by hardware circuitry aside from the CPU 401. The memory 410 is a storage device including a ROM, a RAM, an SSD, an HDD, and the like. The CPU 401 is connected to the control apparatus 40 through a communication circuit 420, and receives various types of commands and data, sends execution results, and the like.

A job control unit 402 executes job data 411 from the control apparatus 40 through the communication circuit 420. The job data 411 includes information indicating the content of the job, for example. A conveyance control unit 406 starts the rotation of the motor M1 in accordance with a rotation command received from the control apparatus 40. The conveyance control unit 406 stops the rotation of the motor M1 in accordance with a stop command received from the control apparatus 40. The conveyance rollers 63 driven by the motor M1 rotate, stop, or the like as a result.

A flapper control unit 407 drives the solenoids SL1 and SL2 to switch the flappers F1 and F2 in accordance with switching commands received from the control apparatus 40 for each sheet P. The discharge destination of the sheet P is set as a result. Instead of switching commands received from the control apparatus 40, the flappers F1 and F2 may be controlled based on the inspection result received from the inspection apparatus 50.

If the stacking apparatus 60c is a post-processing apparatus, the stacking apparatus 60c includes a post-processing control unit 408. The post-processing control unit 408 controls the post-processing unit 68 in accordance with post-processing execution commands received from the control apparatus 40.

### (5) Host Computer

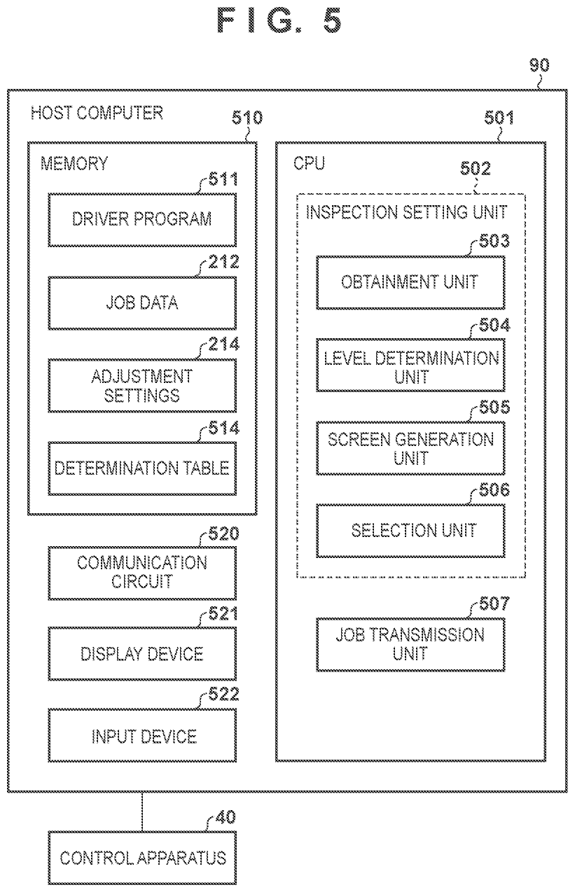

As illustrated in FIG. 5, the host computer 90 includes a CPU 501, a memory 510, a communication circuit 520, an input device 522, and a display device 521. The memory 510 is a storage device including a ROM, a RAM, an SSD, an HDD, and the like. The CPU 501 is connected to the control apparatus 40 through the communication circuit 520, and sends various types of commands and data, receives inspection results, and the like. The communication circuit 520 is communication circuitry for communicating with other devices over a wired network or a wireless network. The input device 522 includes a keyboard, a touch panel, or a pointing device. The display device 521 is a liquid crystal display, an organic EL display, or the like. “EL” is an acronym for “electroluminescence”.

The CPU 501 implements various functions by executing a driver program 511 stored in the memory 510. An inspection setting unit 502 and the inspection setting unit 202 included in the control apparatus 40 can each execute equivalent inspection settings. The inspection setting units 202 and 502 include various functions, such as those described as examples below. An obtainment unit 503 obtains the adjustment settings 214 of the image forming apparatus 30 from the control apparatus 40, and stores the settings in the memory 510. A level determination unit 504 determines the inspection level corresponding to the adjustment settings 214. There are N inspection levels for the image inspection (where N is an integer of 2 or more). If the inspection level is set too high to fit the printing capabilities of the image forming apparatus 30 or the adjustment settings 214, a large number of sheets P will be determined to have failed. Discarding such sheets P, executing reprints, and the like waste significant amounts of the user's time. Toner and sheets are also wastefully consumed. Accordingly, the level determination unit 504 specifies M inspection levels that fit the printing capabilities of the image forming apparatus 30 or the adjustment settings 214, and identifies N-M inspection levels that do not fit the printing capabilities of the image forming apparatus 30 or the adjustment settings 214. M is a positive integer lower than N. A screen generation unit 505 generates a settings screen for the user to make the inspection settings, and causes the display device 521 to display the settings screen. A selection unit 506 selects a single inspection level from a plurality of inspection levels displayed in the settings screen as options, in accordance with an instruction from the user. The selection unit 506 may determine the inspection level corresponding to the adjustment settings 214 by referring to a determination table 514 stored in the memory 510. The determination table 514 may hold relationships between the adjustment settings 214 and all the inspection levels that can be selected. The determination table 514 may hold relationships between the adjustment settings 214 (e.g., the execution frequency of the adjustment processing) and all the inspection levels that are unselectable. The determination table 514 may hold relationships between the adjustment settings 214 and an upper limit value for the inspection level that can be selected. Note that “unselectable” in the following also includes situations where an inspection level actually cannot be selected, and where a specific inspection level can be selected but selecting that inspection level is not recommended. In other words, “unselectable” can also include a situation where the selection is not recommended.

A job sending unit 507 generates the job data 212 in accordance with user instructions input from the input device 522, and sends the job data 212 to the control apparatus 40. The job data 212 includes control information for causing the image forming system 100 to execute a print job or an inspection job.

### (5) Settings Screen (User Interface)

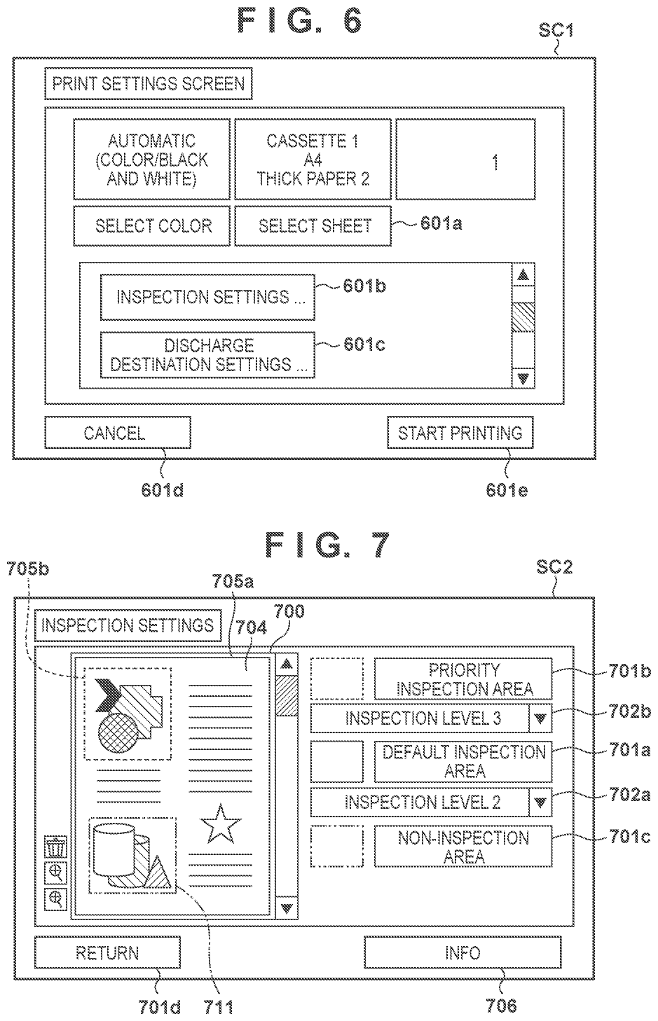

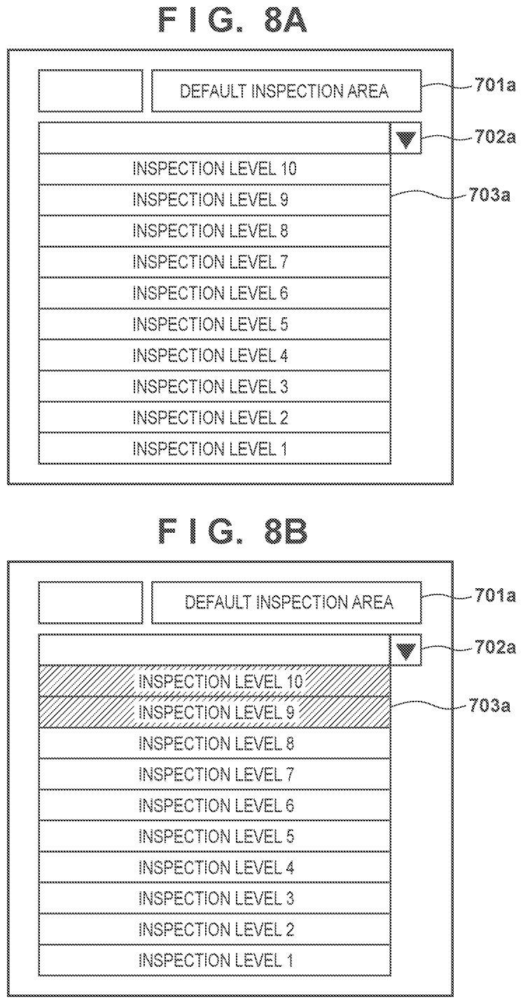

FIG. 6 illustrates a print settings screen SC1 displayed in the display device 21 or the display device 521. The print settings screen SC1 may be called a “job input screen”. A button 601a is a button for designating of the size of the sheet P to be printed on (including the length of the sheet in the conveyance direction), the basis weight, and the sheet cassette 11. A button 601b is a button for instructing a transition from the print settings screen SC1 to an inspection settings screen SC2 (FIG. 7). A button 601c is a button for instructing a transition from the print settings screen SC1 to a discharge destination settings screen. The discharge destination settings screen is a screen for accepting the selection or designation of a sheet tray to which sheets P which have passed the inspection are to be discharged, and a sheet tray to which sheets P which have failed the inspection are to be discharged. A button 601d is a button for instructing the content of the settings to be cancelled. When the button 601d is operated by an operator (the user), the screen transitions to a predetermined default screen. A button 601e is a button for instructing printing to start.

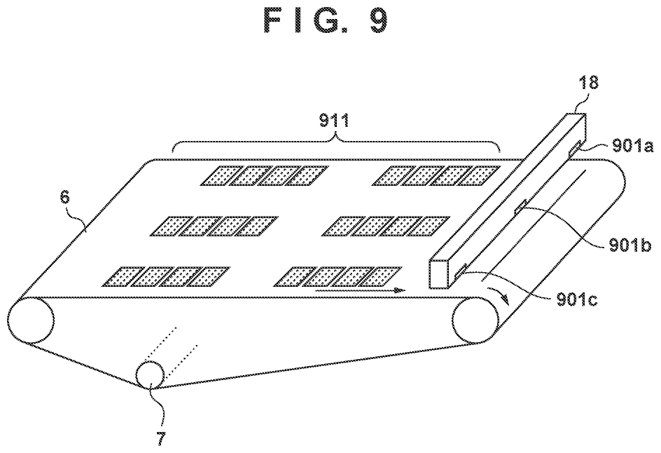

FIG. 7 illustrates the inspection settings screen SC2 displayed in the display device 21 or the display device 521. The inspection settings screen SC2 accepts instructions from the operator for setting an inspection area, the inspection content, and the inspection level for the quality inspection performed by the inspection apparatus 50. In FIG. 7, a display region 700 displays an image 704 to be printed, inspection areas 705a and 705b, an inspection exclusion area 711, and the like. The operator sets the inspection areas 705a and 705b and the inspection exclusion area 711 for the image 704 by operating the input device 22 or the input device 522. The inspection area 705a is a default inspection area set by operating a button 701a. The default inspection area is, for example, an inspection area inspected according to default content. A menu 702a is a pull-down list for setting the inspection level (inspection accuracy) to be applied to the inspection area 705a. When the menu 702a is operated from the input device 22 or the input device 522, the entirety of a list 703a included in the menu 702a is displayed, as illustrated in FIG. 8A. The menu 702a may be called a “pull-down menu” or a “drop-down list”. In this example, inspection level 1 has the lowest inspection accuracy. The inspection accuracy increases as the number of the inspection level increases. The user selects an inspection level for the deliverable from the list 703a.

The inspection area 705b is a priority inspection area set by operating a button 701b. The priority inspection area is, for example, an inspection area to be inspected at a high level of accuracy. In the example illustrated in FIG. 7, the graphic including the circle, the cross, and the like is subject to the high-accuracy inspection.

A menu 702b is a pull-down list for setting the inspection level (inspection accuracy) to be applied to the inspection area 705b. Like the menu 702a, a list included in the menu 702b is displayed when the menu 702b is operated.

The inspection exclusion area 711 is an area that is set not to be inspected, by operating a button 701c. For example, the cylinders and triangle may not require a high-accuracy inspection. A region including these graphics may therefore be set to the inspection exclusion area 711. In this manner, the inspection level can be set for each of regions present in the print target. The user can therefore set appropriate passing criteria. As a result, a printed product having a permissible quality is determined to pass, which reduces wasteful reprinting and improves productivity. The wasteful discarding of sheets P is also reduced.

A button 706 is a button for displaying detailed information about an inspection level that has become unselectable. The detailed information includes, for example, the reason why the inspection level is unselectable and conditions (e.g., the details of a task) required to change the inspection level to selectable. A button 701d is a button for returning to the print settings screen SC1 from the inspection settings screen SC2.

### (6) Hiding Unselectable Inspection Level

The host computer 90 obtains the adjustment settings 214 (e.g., the execution frequency of the adjustment processing) from the control apparatus 40, and stores the adjustment settings 214 in the memory 510.

If the adjustment settings 214 are appropriate, the performance of the image forming apparatus 30 will remain at a sufficient level, which makes it possible to set a high inspection level. However, if the adjustment settings 214 are inappropriate, the performance of the image forming apparatus 30 will no longer remain at a sufficient level. If a high inspection level is set in such a case, there may be many sheets P which cannot pass the inspection. Inspection levels that do not fit the adjustment settings 214 should therefore be made unselectable.

FIG. 8B illustrates an example in which inspection level 9 and inspection level 10 are displayed as unselectable in the list 703a of the menu 702a. In this example, inspection level 9 and inspection level 10 are grayed out. As a result, the operator can select one of inspection levels 1 to 8. Inspection level 9 and inspection level 10 need not be displayed.

On the other hand, as illustrated in FIG. 8A, inspection level 9 and inspection level 10 may be displayed as selectable in the list 703a of the menu 702a. When the user selects inspection level 9 and inspection level 10, a message prompting the user to review the selection may be displayed in the display device 521. The message may include, for example, a notification indicating to the user that inspection level 8 or lower should be selected. This makes it possible for the user to select an inspection level that fits the accuracy of the image formation. Note that graying out inspection level 9 and inspection level 10 and the making a notification prompting the inspection level to be changed corresponding to prohibiting the selection of inspection level 9 and inspection level 10, respectively.

### (9) Adjustment Processing

The performance of the image forming apparatus 30 gradually decreases as the total number of sheets P on which images have been formed increases. This will be called a “change over time”. Environmental conditions such as temperature, humidity, or the like may also cause variations in performance. Deformation of the components of the image forming apparatus 30 can also result in such variations. When a specific condition is satisfied, the image forming system 100 generates a test image and adjusts the image forming conditions 215. Doing so keeps the performance (image quality) constant.

Tone correction is one type of adjustment processing. Developers 4Y, 4M, 4C, and 4K form toner images using Y, M, C, and K color toners, respectively, in order to form a color image. Tone correction is control for stabilizing the darkness of a half-tone reproduced by a dither pattern. The half-tone of the image data included in a print job is replaced with a dither pattern by the job processing unit 206 and converted into an image signal. Exposure devices 3Y, 3M, 3C, and 3K expose the corresponding photosensitive members 1Y, 1M, 1C, and 1K in accordance with the image signal supplied by the job processing unit 206. The stability of toner dots for forming the dither pattern changes depending on the state of the toner contained in the developers 4Y, 4M, 4C, and 4K. This may cause a decrease in the reproducibility of the half-tone in images formed on the sheets P.

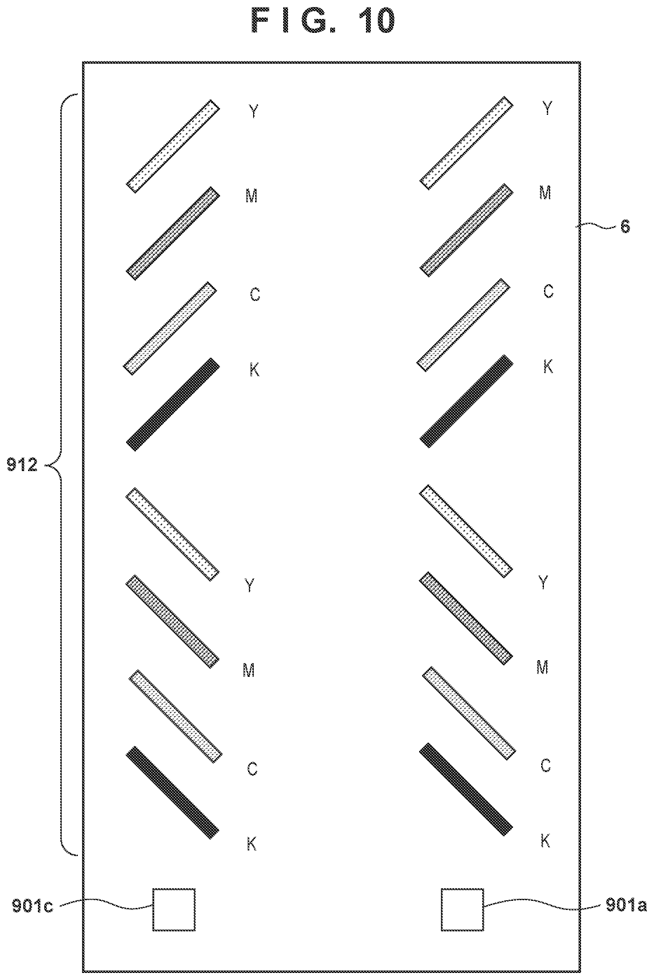

FIG. 9 illustrates a test image 911 for tone correction, formed on the intermediate transfer belt 6. The test image 911 includes a half-tone test pattern formed in each of yellow, magenta, cyan, and black. The light sensor 18 includes light intensity sensors 901a, 901b, and 901c, each disposed at a different position in the main scanning direction. The main scanning direction is the direction orthogonal to the direction in which the image is conveyed (the sub scanning direction). Each of the light intensity sensors 901a, 901b, and 901c includes a light-emitting element (e.g., an LED) that emits light toward the test image 911, and a light-receiving element that receives reflected light from the test image 911. Each of the light intensity sensors 901a, 901b, and 901c separates the reflected light into regularly-reflected light and irregularly-reflected light components, and converts the intensity of the regularly-reflected light component and the intensity of the irregularly-reflected light component into corresponding digital values. Each of the light intensity sensors 901a, 901b, and 901c computes the darkness of the half-tone by substituting these digital values in a calculation formula suited to each color. The adjustment processing unit 207 generates a lookup table (LUT) that inverse-corrects the image data in advance such that the darknesses of the half-tones for yellow, magenta, cyan, and black take on predetermined darknesses. By having the CPU 201 correct the image data prepared by the user using the LUT, the tone properties of the image data and the tone properties of the image formed on the sheet P substantially match. This LUT is one of the image forming conditions 215.

The tone correction (adjustment processing for generating or updating the LUT) is executed between a preceding page and a following page (a sheet interval). To achieve more precise tone correction, the adjustment processing unit 207 may extend the sheet interval and form more test patterns. This improves the reproducibility of the tone properties from low-darkness ranges to high-darkness ranges. In other words, the tint of the output is adjusted to an appropriate tint, and the output can pass the tint inspection.

The execution interval of the adjustment processing (e.g., tone correction) may be set by the user. In the present embodiment, the default value of the execution interval is 100 sheets. In other words, the adjustment processing unit 207 executes the adjustment processing each time the image forming apparatus 30 forms images on 100 sheets P.

Note that the test image 911 may be transferred to a sheet P, and the test image 911 on the sheet P may be read by the image sensors 54 and 55. The adjustment processing unit 207 may obtain a reading result of the test image 911 by the image sensors 54 and 55 based on the execution interval set by the user, and generate the LUT. The tone correction using the test image 911 formed on the sheet P is more accurate than the tone correction using the test image 911 formed on the intermediate transfer belt 6. This is because the tint of the test image 911 formed on the sheet P is closer to the tint of the output, compared to the tint of the test image 911 formed on the intermediate transfer belt 6.

Only one of tone correction using the test image 911 formed on the intermediate transfer belt 6 and tone correction using the test image 911 formed on the sheet P may be used, or both may be used. Tone correction using the test image 911 formed on the intermediate transfer belt 6 has the advantage of not consuming sheets P. Accordingly, the execution frequency of the tone correction using the test image 911 formed on the intermediate transfer belt 6 may be set to be higher, and the execution frequency of the tone correction using the test image 911 formed on the sheet P may be set to be lower. In either case, the execution frequency is set by the user.

Misalignment adjustment is one type of the adjustment processing. In the misalignment adjustment, the position at which each of the Y, M, C, and K images is formed is adjusted. The misalignment adjustment includes adjusting the writing position of the image in the sub scanning direction, adjusting the magnification of the image in the sub scanning direction, adjusting the writing position of the image in the main scanning direction, and adjusting the magnification of the image in the main scanning direction.

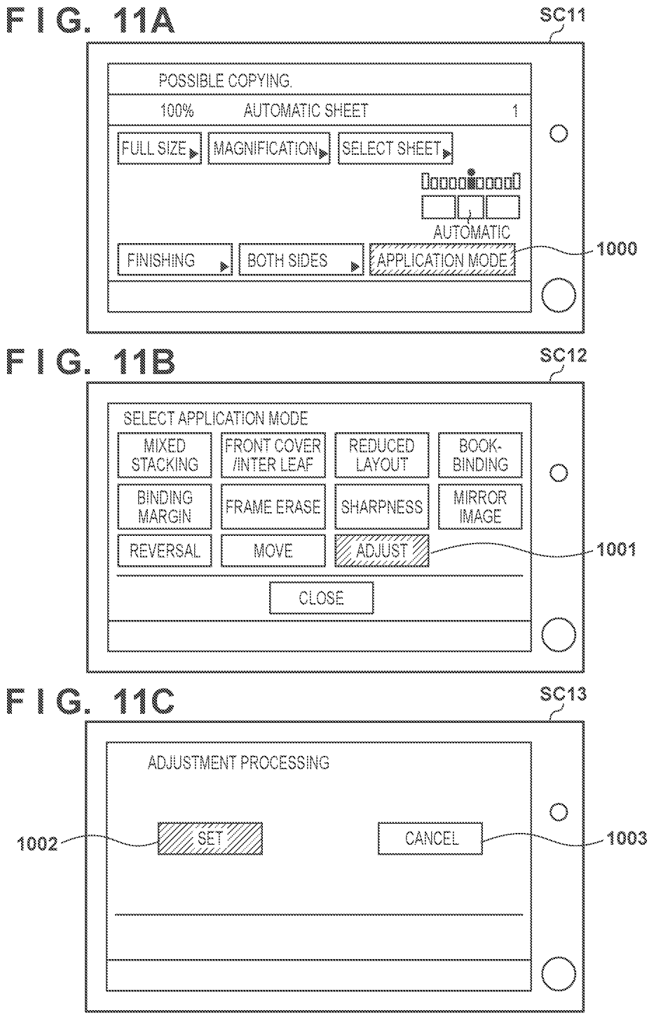

FIG. 10 illustrates a test image 912 for misalignment adjustment, formed on the intermediate transfer belt 6. When the position at which each of the Y, M, C, and K images is formed is shifted from the ideal position, color shift occurs. “Color shift” refers to an amount of shift in the image formation position of a given color relative to the image formation position of a reference color. The reference color is yellow, for example. The test image includes at least two pattern columns. One of the pattern columns is detected by the light intensity sensor 901a. The other pattern is detected by the light intensity sensor 901c. The adjustment processing unit 207 finds a time difference between the timing at which the pattern of the reference color is detected and the timing at which the other pattern is detected, and adjusts the writing timing of the image of each color in accordance with the time difference. Misalignment among the colors is adjusted as a result. This makes it possible for the output to pass the misalignment inspection.

Incidentally, black spots produced in the output are unexpected images that are not present in the original document. It is known that such black spots do not decrease even if some kind of adjustment is made. Accordingly, the upper limit value of the inspection level for black spots may be kept constant regardless of the execution frequency of the adjustment processing.

### (10) Adjustment Processing Setting Method

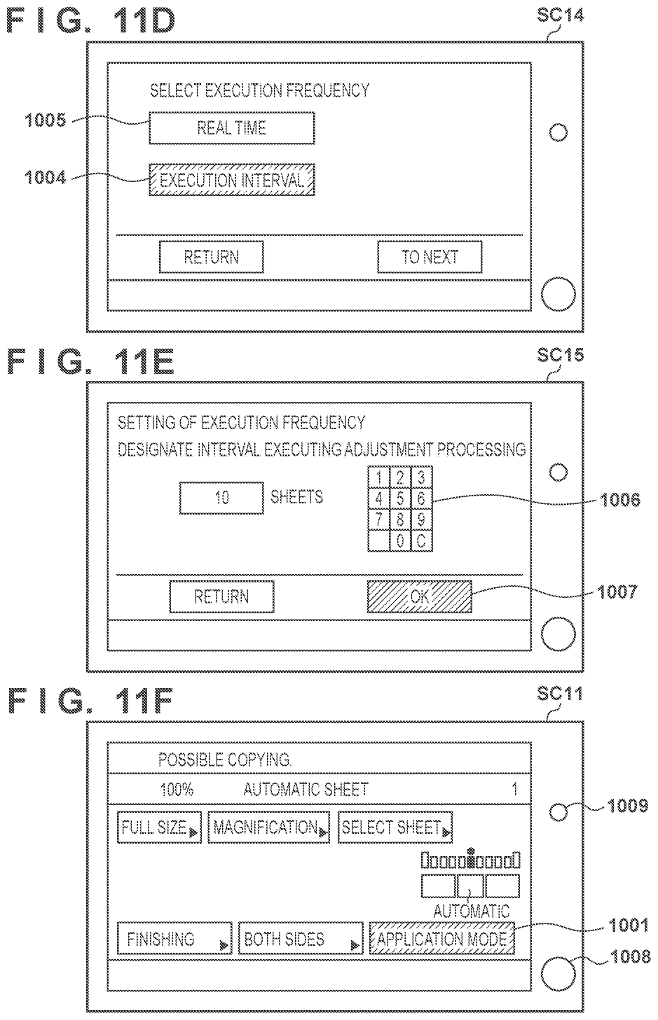

FIGS. 11A to 11F illustrate settings screens SC11 to SC15 for setting the adjustment processing in the image forming conditions 215 (e.g., geometric properties and tone properties). The user operates the input devices 22 and 522 while looking at the settings screens SC11 to SC15, which are displayed in the display devices 21 and 521. Atone correction setting method will be described here as a representative example of a plurality of types of adjustment processing. The user sets the tone correction before instructing the printing to be executed. Although the setting method is described as being executed by the control apparatus 40 in the following, the setting method may be executed remotely by the host computer 90. In the latter case, the adjustment setting unit 208 is implemented by the CPU 501.

As illustrated in FIG. 11A, the adjustment setting unit 208 displays the settings screen SC11 in the display device 21. A button 1000 is provided in the settings screen SC11, and is a software key for selecting an “application mode”. Upon detecting that the button 1000 has been operated by the user, the adjustment setting unit 208 displays the settings screen SC12 in the display device 21. As illustrated in FIG. 11B, the settings screen SC12 displays a plurality of application modes as options. A button 1001 is a software key for selecting an “adjustment” mode. When the button 1001 is operated, the adjustment setting unit 208 displays the settings screen SC13 in the display device 21.

As illustrated in FIG. 11C, the settings screen SC13 is a settings screen for the adjustment processing (e.g., tone correction). A button 1002 is a software key that calls a settings screen for enabling the adjustment processing and setting the execution interval for the adjustment processing. A button 1003 is a software key for cancelling (disabling) the adjustment processing. When the button 1002 is operated, the adjustment setting unit 208 displays the settings screen SC14. When the button 1003 is operated, the adjustment setting unit 208 displays the settings screen SC12.

As illustrated in FIG. 11D, a settings screen SC14 is a screen for setting the execution frequency (execution interval) of the adjustment processing. A button 1004 is a software key for calling the settings screen SC15 for setting the execution frequency (execution interval). The button 1005 is a software key for instructing the adjustment processing to be executed immediately. When the button 1004 is pressed, the adjustment setting unit 208 displays the settings screen SC15 in the display device 21. When the button 1005 is pressed, the adjustment processing unit 207 starts the adjustment processing. Alternatively, an operation mode in which a test image is formed on all pages in real time may be selected when the button 1005 is pressed.

As illustrated in FIG. 11E, the settings screen SC15 includes numeric input keys 1006 for setting the execution frequency (execution interval). By operating the numeric input keys 1006, the user can set a desired execution interval (number of sheets). Note that a plurality of options for execution intervals may be displayed, and one of the execution intervals may be selected therefrom by the user. In this example, the adjustment processing is executed once each time images are formed on 10 sheets P or pages. A button 1007 is a software key for enabling the setting of the execution interval and calling the settings screen SC11. When the button 1007 is pressed, the settings screen SC11 is displayed in the display device 21 again, as illustrated in FIG. 11F. The adjustment setting unit 208 generates the adjustment settings 214, which include information indicating whether the adjustment processing is enabled or disabled and information indicating the execution interval, and stores the adjustment settings 214 in the memory 210.

The settings screen SC11 includes a print button 1008 and an interrupt button 1009. When the user presses the print button 1008, the CPU 201 executes printing. When the adjustment settings 214 indicate that adjustment processing is enabled, the adjustment processing unit 207 executes the adjustment processing at an execution interval according to the adjustment settings 214. In other words, the adjustment processing unit 207 controls the image forming apparatus 30 to form a test image on the intermediate transfer belt 6, obtains a result of detecting the test image from the light sensor 18, and adjusts (corrects) the image forming conditions 215 based on the detection result. If the adjustment processing is tone correction, the LUT, which is part of the image forming conditions 215, is corrected. If the adjustment processing is disabled, the adjustment processing unit 207 skips the adjustment processing.

When the interrupt button 1009 is pressed, the CPU 201 suspends the job currently being executed and executes another print job (an interrupt job). The adjustment processing can also be applied to the interrupt job. When the user presses the interrupt button 1009, the adjustment setting unit 208 may display the settings screens SC12 to SC15 in the display device 21 and accept the input of the adjustment settings 214. For example, the execution interval may be set to three sheets, and the print button 1008 may then be pressed. As a result, in the interrupt job, the adjustment processing is executed each time images are formed on three sheets P.

### (11) Image Quality And Adjustment Frequency Satisfying Inspection Level

The relationship between the execution interval for tone correction and the inspection level that can be passed will be described as an example. However, the relationships described below apply to misalignment adjustment as well.

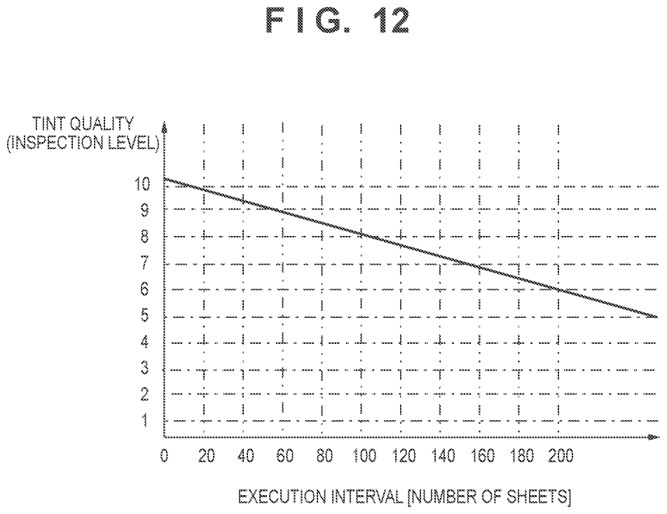

FIG. 12 illustrates a relationship between the execution interval of the adjustment processing and the inspection level that can be passed. The horizontal axis represents the execution interval (number of sheets). The vertical axis represents the inspection level. Immediately after the tone correction is executed, the image forming apparatus 30 is in a state where a high inspection level can be passed. The inspection level that can be passed gradually decreases as the number of sheets P on which images are formed increases thereafter. According to FIG. 12, even with a printer engine A for which the tint is “mid” quality, the inspection level “10”, which is a high inspection level, can be passed for a period of time after executing tone correction. However, as the total number of images formed increases, the toner contained in the developer 4 decreases. In other words, the darkness of the half-tone changes over time. If the execution interval for the tone correction is too long, the tint quality may fail the inspection before the next tone correction is executed. In such a case, if the user sets a higher inspection level for the tint, sheets P which fail early may begin to appear. For example, if the inspection level is set to the maximum value of 10, a sheet P will fail after about 10 sheets P are printed. Accordingly, the image forming system 100 assists the user in selecting an inspection level that fits the execution frequency.

For example, setting the execution interval to one sheet increases the probability that sheets P can pass the tint inspection at inspection level 10. Setting the execution interval to 50 sheets increases the probability that sheets P can pass the tint inspection at inspection level 9. Setting the execution interval to 100 sheets increases the probability that sheets P can pass the tint inspection at inspection level 8. This relationship between the execution interval and the inspection level may be held in the determination table 514. The determination table 514 may be realized by a mathematical function or a programmatic function (module). Three options (one sheet, 50 sheets, and 100 sheets) are illustrated as execution frequencies in this example. However, it is sufficient for the number of selectable execution frequencies to be at least two.

The execution frequency of the adjustment processing and the inspection level are selected by the user. If an inspection level that does fit the execution frequency is selected, the number of sheets P that will fail will increase unintentionally. A user interface that can assist in setting the inspection level of the user is therefore necessary. In particular, as illustrated in FIG. 8B, inspection levels that do not match the execution frequencies may be grayed out.

### (12) Flowcharts

### (12-1) Inspection Settings

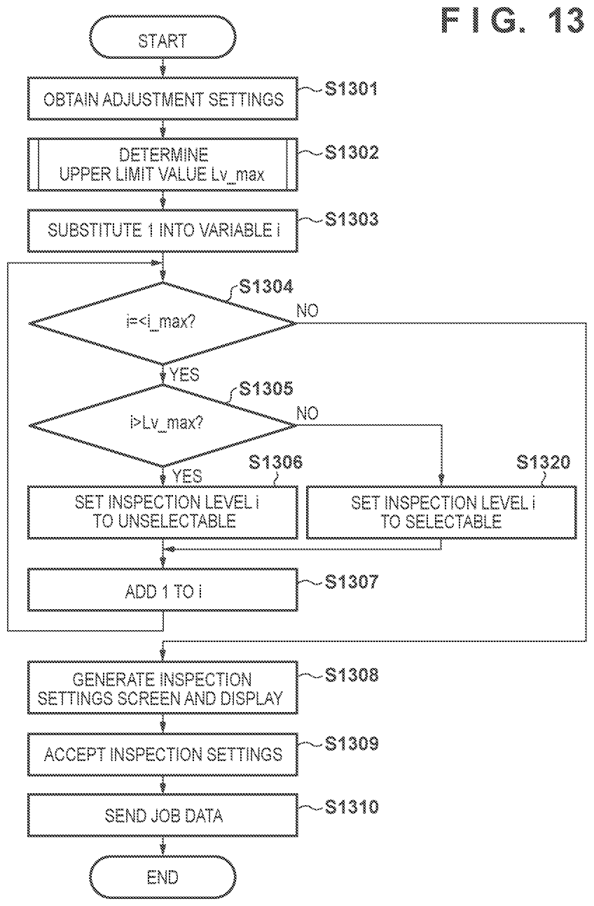

FIG. 13 illustrates the inspection settings made by the CPU 201 or the CPU 501. The inspection settings will be described as being made by the CPU 501 as an example. For example, the inspection settings are made when the button 601b is pressed.

In step S1301, the CPU 501 (the obtainment unit 503) obtains the adjustment settings 214 of the image forming apparatus 30. For example, the CPU 501 accesses the control apparatus 40 through the communication circuit 520, and obtains the adjustment settings 214 of the image forming apparatus 30. Alternatively, the CPU 501 accesses a server (not shown) through the communication circuit 520, and obtains the adjustment settings 214 of the image forming apparatus 30. Or, the CPU 501 obtains the adjustment settings 214 of the image forming apparatus 30 from the memory 510.

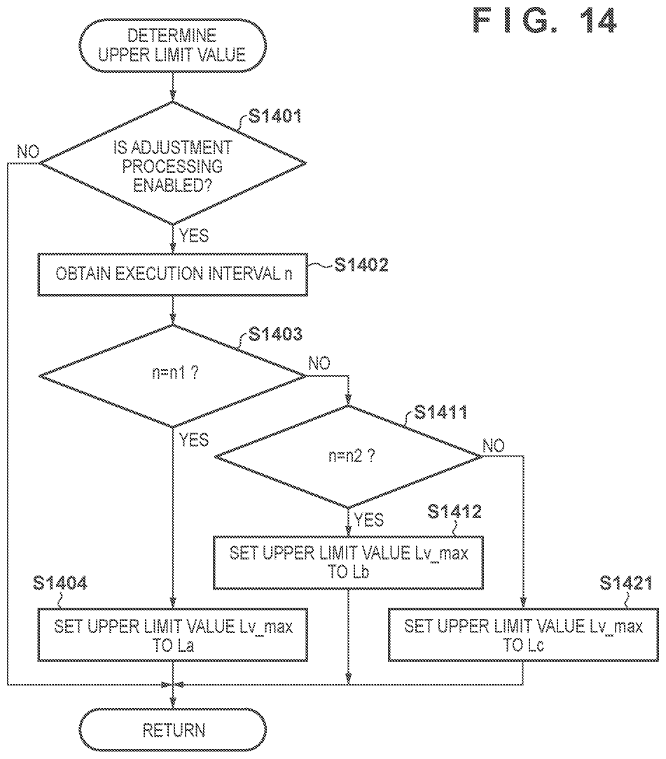

In step S1302, the CPU 501 (the level determination unit 504) determines an upper limit value Lv_max of the inspection level corresponding to the adjustment settings 214. Step S1302 will be described in detail later with reference to FIG. 14.

In step S1303, the CPU 501 (the screen generation unit 505) substitutes 1 for a variable i. The variable i is an index indicating an inspection level of interest. In this example, i is an integer from 1 to 10.

In step S1304, the CPU 501 (the screen generation unit 505) determines whether the variable i is no greater than a maximum value i_max for the inspection level. As illustrated in FIG. 8A, the maximum value i_max is 10 in the present embodiment. If the variable i exceeds the maximum value i_max for the inspection level, the CPU 501 moves the sequence from step S1304 to step S1308. If the variable i is no greater than the maximum value i_max for the inspection level, the CPU 501 moves the sequence from step S1304 to step S1305.

In step S1305, the CPU 501 (the screen generation unit 505) determines whether the variable i exceeds the upper limit value Lv_max. If the variable i exceeds the upper limit value Lv_max, the CPU 501 moves the sequence from step S1305 to step S1306.

In step S1306, the CPU 501 (the screen generation unit 505) sets the inspection level i to unselectable. For example, the inspection level i is grayed out in the list 703a of the menu 702a. The CPU 501 then moves the sequence from step S1306 to step S1307.

In step S1307, the CPU 501 (the screen generation unit 505) adds 1 to the variable i. The CPU 501 then moves the sequence from step S1307 to step S1304.

On the other hand, if the variable i does not exceed the upper limit value Lv_max, the CPU 501 moves the sequence from step S1305 to step S1320. In step S1320, the CPU 501 (the screen generation unit 505) sets the inspection level i to selectable. The CPU 501 then moves the sequence from step S1320 to step S1307.

In step S1308, the CPU 501 (the screen generation unit 505) generates the inspection settings screen SC2 and displays the screen in the display device 521. For example, the CPU 501 generates the list 703a of the menu 702a based on the unselectable/selectable settings for inspection levels 1 to i_max, and generates the inspection settings screen SC2 including the menu 702a.

In step S1309, the CPU 501 (the selection unit 506) accepts the inspection settings through the inspection settings screen SC2. When the button 601d is pressed, and the button 601e is further pressed in the print settings screen SC1, the CPU 501 moves the sequence from step S1309 to step S1310.

In step S1310, the CPU 501 (the job sending unit 507) generates the job data 212 based on the inspection settings and sends the job data 212 to the control apparatus 40. The control apparatus 40 controls the image forming system 100 according to the job data 212 to form an image on a sheet P and inspect the formed image.

If the inspection settings are made by the CPU 201 of the control apparatus 40, “CPU 501” is replaced with “CPU 201”, and “memory 510” with “memory 210”, in the foregoing descriptions. In other words, the inspection setting unit 502 illustrated in FIG. 5 is implemented by the CPU 201 as the inspection setting unit 202. Furthermore, “input device 522” is replaced with “input device 22”. “Display device 521” is replaced with “display device 21”. In this manner, the inspection settings may be made in the host computer 90, or may be made in the control apparatus 40.

### (12-2) Method for Determining Upper Limit Value

FIG. 14 illustrates step S1302, illustrated in FIG. 13, in detail. In step S1401, the CPU 501 (the level determination unit 504) determines whether the adjustment processing is enabled based on the adjustment settings 214. If the adjustment processing is enabled, the CPU 501 moves the sequence from step S1401 to step S1402. If the adjustment processing is disabled, the CPU 501 assigns a default value to the upper limit value Lv_max, and moves the sequence from step S1401 to step S1303 in FIG. 13.

In step S1402, the CPU 501 (the level determination unit 504) obtains an execution interval n included in the adjustment settings 214.

In step S1403, the CPU 501 (the level determination unit 504) determines whether the execution interval n is a predetermined value n1 (e.g., n1=1). If the execution interval n is equal to the predetermined value n1, the CPU 501 moves the sequence from step S1403 to step S1404.

In step S1404, the CPU 501 (the level determination unit 504) sets the upper limit value Lv_max to a predetermined value La (e.g., La=10). The CPU 501 then moves the sequence from step S1404 to step S1303 in FIG. 13.

If in step S1403 it is determined that the execution interval n is not equal to the predetermined value n1, the CPU 501 moves the sequence from step S1403 to step S1411. In step S1411, the CPU 501 (the level determination unit 504) determines whether the execution interval n is a predetermined value n2 (e.g., n2=50). n2 is greater than n1. If the execution interval n is equal to the predetermined value n2, the CPU 501 moves the sequence from step S1411 to step S1412.

In step S1412, the CPU 501 (the level determination unit 504) sets the upper limit value Lv_max to a predetermined value Lb (e.g., Lb=9). Lb is smaller than La. The CPU 501 then moves the sequence from step S1412 to step S1303.

If in step S1411 it is determined that the execution interval n is not equal to the predetermined value n2, the CPU 501 moves the sequence from step S1411 to step S1421. In step S1421, the CPU 501 (the level determination unit 504) sets the upper limit value Lv_max to a predetermined value Lc (e.g., Lc=8). Lc is smaller than Lb. The CPU 501 then moves the sequence from step S1421 to step S1303.

### (12-3) Control Apparatus Operations

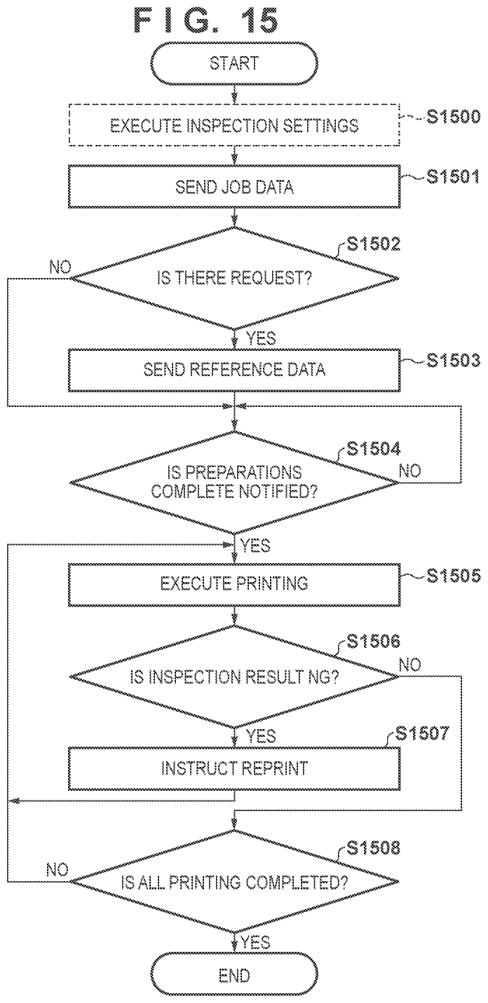

FIG. 15 is a flowchart illustrating printing processing executed by the CPU 201 of the control apparatus 40. The CPU 201 executes the following processing when printing is instructed to start in response to the button 601e being pressed.

In step S1500, the CPU 201 (the inspection setting unit 202) executes steps S1301 to S1309 and step S1320 illustrated in FIG. 13. Note that step S1500 is skipped if the inspection settings are made in the host computer 90.

In step S1501, the CPU 201 (the job processing unit 206) generates the job data 314, including sheet information, the inspection settings, discharge destination information, and the like, based on the job data 212, and sends the job data 314 to the inspection apparatus 50. The sheet information includes the size, the number, and the like of the sheets P. The inspection settings include whether to perform an inspection, and the content of the inspection performed by the inspection apparatus 50 (the inspection area, the inspection level, and the like). The discharge destination information includes identification information of one of the stacking apparatuses 60a to 60c to serve as the discharge destination, and identification information of trays for a passing tray and a failing tray. The “passing tray” is a sheet tray to which sheets P which have passed the inspection are discharged. The “failing tray”, meanwhile, is a sheet tray to which sheets P which have not passed the inspection are discharged. The passing tray and the failing tray are assumed to be selected in a screen displayed when the button 601c is pressed.

In step S1502, the CPU 201 (the inspection control unit 205) determines whether a request to send the reference data 211 has been received from the inspection apparatus 50. If no request has been received, the CPU 201 moves the sequence to step S1504. If a request has been received, the CPU 201 moves the sequence to step S1503.

In step S1503, the CPU 201 (the inspection control unit 205) reads out the reference data 211 from the memory 210 and sends the reference data 211 to the inspection apparatus 50.

In step S1504, the CPU 201 (the job processing unit 206) determines whether a notification indicating preparations are complete has been made by the inspection apparatus 50. The CPU 201 moves the sequence to step S1505 when a notification indicating preparations are complete has been made by the inspection apparatus 50.

In step S1505, the CPU 201 (the job processing unit 206) prints onto the sheet P by controlling the image forming apparatus 30.

In step S1506, the CPU 201 (the inspection control unit 205) determines whether the inspection result received from the inspection apparatus 50 is “no good” (fail). If the inspection result is “pass”, the CPU 201 moves the sequence from step S1506 to step S1508. If the inspection result is “no good”, the CPU 201 moves the sequence from step S1506 to step S1507.

In step S1507, the CPU 201 (the job processing unit 206) instructs the image forming apparatus 30 to reprint. As a result, the image on the sheet P determined to have failed is reprinted onto another sheet P. The CPU 201 then moves the sequence from step S1507 to step S1505. Note that the reprinting may be scheduled to be performed after the printing has ended for all the pages based on the job data 212. In other words, the job data 212 for reprinting may be generated.

In step S1508, the CPU 201 (the job processing unit 206) determines whether all the printing based on the job data 212 is complete. If a page to be printed remains, the CPU 201 moves the sequence to step S1505, and prints the next page. If no pages remain to be printed, the CPU 201 ends the print job.

### (12-4) Inspection Apparatus Operations

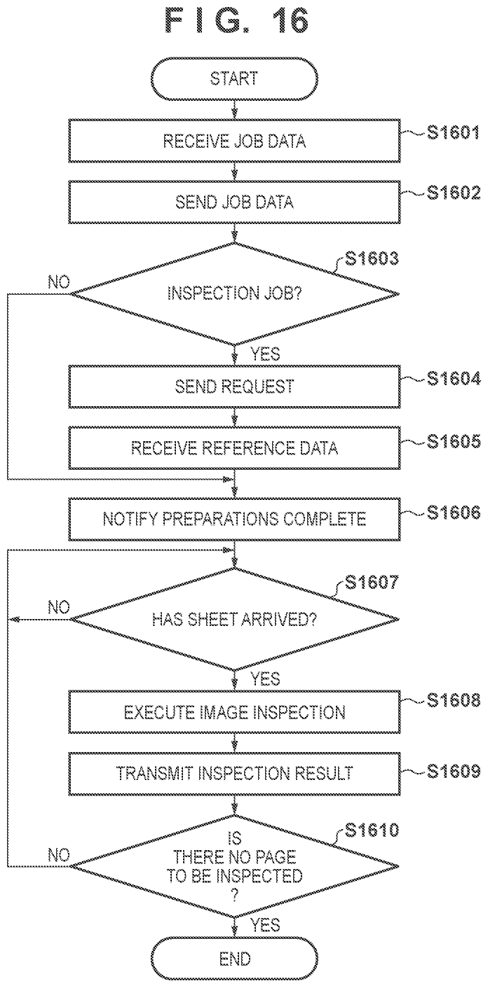

FIG. 16 is a flowchart illustrating inspection processing executed by the CPU 301 of the inspection apparatus 50.

In step S1601, the CPU 301 receives the job data 314 from the control apparatus 40. The job data 314 may be stored in the memory 310. Alternatively, the job data 314 may be stored in the memory 310 as part of the job data 212. The job data 314 includes control information for the inspection apparatus 50 and control information applied to the stacking apparatuses 60.

In step S1602, the CPU 301 transmits the job data 411 to the stacking apparatus 60a, which is in a later stage. The job data 411 is part of the job data 314 and includes the control information applied to the stacking apparatuses 60.

In step S1603, the CPU 301 analyzes the job data 314 and determines whether the job data 314 instructs an inspection job to be executed. If no inspection job is instructed, the inspection apparatus 50 executes a conveyance job for conveying the sheet P to the stacking apparatus 60a in a later stage. If an inspection job is instructed, the CPU 301 moves the sequence to step S1604. If no inspection job is instructed, the CPU 301 moves the sequence to step S1606.

In step S1604, the CPU 301 sends, to the control apparatus 40, a request for requesting the reference data 211.

In step S1605, the CPU 301 receives the reference data 211 from the control apparatus 40. The reference data 211 is stored in the memory 310.

In step S1606, the CPU 301 notifies the control apparatus 40 that preparations are complete. The notification that preparations are complete may also be sent to the stacking apparatuses 60a to 60c in later stages.

In step S1607, the CPU 301 determines whether a sheet P has arrived based on a detection signal output from the sheet sensor 56. A “sheet P arriving” means that the sheet sensor 56 has detected the leading end of the sheet P. When a sheet P arrives at the sheet sensor 56, the CPU 301 moves the sequence to step S1608.

In step S1608, the CPU 301 (the reading control unit 307 and the inspection unit 302) executes the image inspection designated by the job data 314. The reading control unit 307 reads the sheet P using the image sensors 54 and 55, and generates the inspection image data 312. Furthermore, the inspection unit 302 inspects the inspection image data 312 in accordance with the inspection settings designated by the job data 314. For example, the inspection unit 302 compares the inspection image data 312 with the reference data 211 and determines whether the image formed on the sheet P satisfies the passing criteria. The passing criteria are the passing criteria corresponding to the inspection level designated by the job data 314.

In step S1609, the CPU 301 (the inspection unit 302) transmits the inspection result to the control apparatus 40 and the stacking apparatuses 60a to 60c. Note that if the job data 314 designates the stacking apparatus 60b as the discharge destination, the inspection result is sent to at least the stacking apparatus 60b. This is because the discharge destination is switched based on the inspection result.

In step S1610, the CPU 201 determines whether there are any pages to be inspected, designated by the job data 314. If there is a remaining page to be inspected, the CPU 301 moves the sequence to step S1607 and waits for the next sheet P to arrive. If no pages remain to be inspected, the CPU 301 ends the job.

### (12-5) Stacking Apparatus Operations

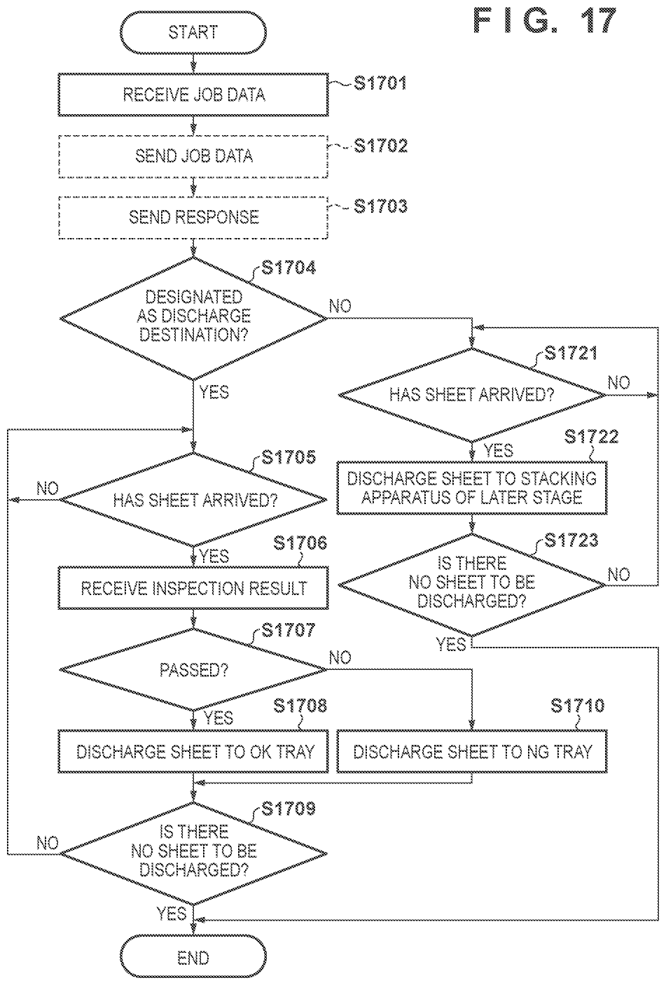

FIG. 17 is a flowchart illustrating conveyance and discharge processing executed by the CPU 401 of the stacking apparatuses 60.

In step S1701, the CPU 401 (the job control unit 402) receives the job data 411 from the inspection apparatus 50 or the stacking apparatus 60 on the upstream side. Note that if a stacking apparatus 60 is present on the downstream side, the CPU 401 moves the sequence to step S1702.

In step S1702, the CPU 401 (the job control unit 402) sends the job data 411 to the stacking apparatus 60 on the downstream side. Note that if the stacking apparatus 60 is the stacking apparatus 60 furthest on the downstream side, in step S1703, a response indicating that the job data 411 has been successfully received is sent to the inspection apparatus 50 or the stacking apparatus 60 on the upstream side. The stacking apparatus 60 on the upstream side forwards the response to the inspection apparatus 50.

In step S1704, the CPU 401 determines whether it itself (i.e., the stacking apparatus 60) is designated as the discharge destination based on the job data 411. If the sheet P will pass through the stacking apparatus 60 itself and be discharged to a stacking apparatus 60 in a later stage, the CPU 401 moves the sequence to step S1721.

In step S1721, the CPU 401 determines whether the sheet P has arrived based on the detection signal from the sheet sensor 66. When the sheet P arrives, the CPU 401 moves the sequence to step S1722.

In step S1722, the CPU 401 controls the motor M1 and the solenoids SL1 and SL2 to discharge the sheet P to the stacking apparatus 60 in the later stage.

In step S1723, the CPU 401 determines whether there is a sheet P to be discharged based on the job data 411. If there is a sheet P remaining to be discharged, the CPU 401 moves the sequence to step S1721. If there is no sheet P remaining to be discharged, the CPU 401 completes the conveyance job.

On the other hand, if the stacking apparatus 60 itself is designated as the discharge destination, the CPU 401 moves the sequence from step S1704 to step S1705. In step S1705, the CPU 401 determines whether the sheet P has arrived based on the detection signal from the sheet sensor 66. When the sheet P arrives, the CPU 401 moves the sequence to step S1706.

In step S1706, the CPU 401 receives the inspection result from the inspection apparatus 50. In step S1707, the CPU 401 determines whether the sheet P has passed the inspection based on the inspection result. If the sheet P has passed the inspection, the CPU 401 moves the sequence to step S1708.

In step S1708, the CPU 401 controls the motor M1 and the solenoids SL1 and SL2, and discharges the sheet P to the passing tray. If the sheet P has not passed the inspection, the CPU 401 moves the sequence to step S1710. In step S1710, the CPU 401 controls the motor M1 and the solenoids SL1 and SL2, and discharges the sheet P to the failing tray. The passing tray and the failing tray are designated in advance by the job data 411.

In step S1709, the CPU 401 determines whether there is a sheet P to be discharged based on the job data 411. If there is a sheet P remaining to be discharged, the CPU 401 moves the sequence to step S1705. If there is no sheet P remaining to be discharged, the CPU 401 completes the discharge job.

According to the present embodiment, an upper limit value for an appropriate inspection level is set in accordance with the performance (the image forming accuracy) of the image forming apparatus 30. This improves the usability for inspections. For example, situations where the image formation and inspections are stopped due to unnecessary failures will decrease. Deliverables which are discarded will be reduced, which ensures that resources such as sheets P, toner, electricity, and the like will be utilized effectively. The productivity of the image forming system 100 will be improved as well.

### (13) Controller of Image Forming Apparatus

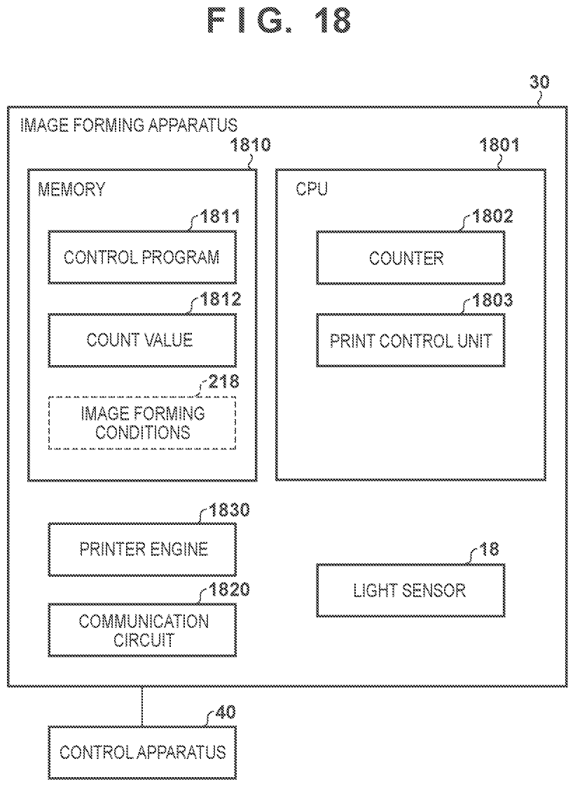

FIG. 18 illustrates an engine controller provided in the image forming apparatus 30. A CPU 1801 controls the image forming apparatus 30 according to a control program 1811 stored in a memory 1810. A counter 1802 counts the number of sheets P on which an image has been formed. A count value 1812 of the counter 1802 may be held in the memory 1810. Upon receiving image forming conditions 218 (e.g., a charging bias, a development bias, a transfer bias, and a maximum light intensity) from the control apparatus 40 through a communication circuit 1820, a print control unit 1803 stores those image forming conditions in the memory 1810. Upon receiving a printing instruction from the control apparatus 40 through the communication circuit 1820, the print control unit 1803 controls a printer engine 1830 to form an image on a sheet P according to the image forming conditions 218. Upon receiving an instruction to detect a test image from the control apparatus 40 through a communication circuit 1820, the print control unit 1803 causes the light sensor 18 to detect the test image. The print control unit 1803 sends the count value 1812 and the result of detecting the test image to the control apparatus 40 or the inspection apparatus 50 through the communication circuit 1820. The count value 1812 is used by the adjustment processing unit 207 to detect the timing of the execution of the adjustment processing. The printer engine 1830 includes a motor that conveys the sheet P within the image forming apparatus 30, components involved in image formation (e.g., the photosensitive member 1, the charger 2, the exposure device 3, the developer 4, the primary transfer roller 5, the intermediate transfer belt 6, the secondary transfer section 7, and the fixer 8), and the like. As described above, the controller illustrated in FIG. 18 may be included in the control apparatus 40.

### (14) Advice to User

As described above, inspection levels that do not fit the execution interval are grayed out. However, the user may wish to prioritize a higher inspection level over the downtime involved in the adjustment processing. In this case, advice which enables the user to select their desired inspection level would be useful for the user.

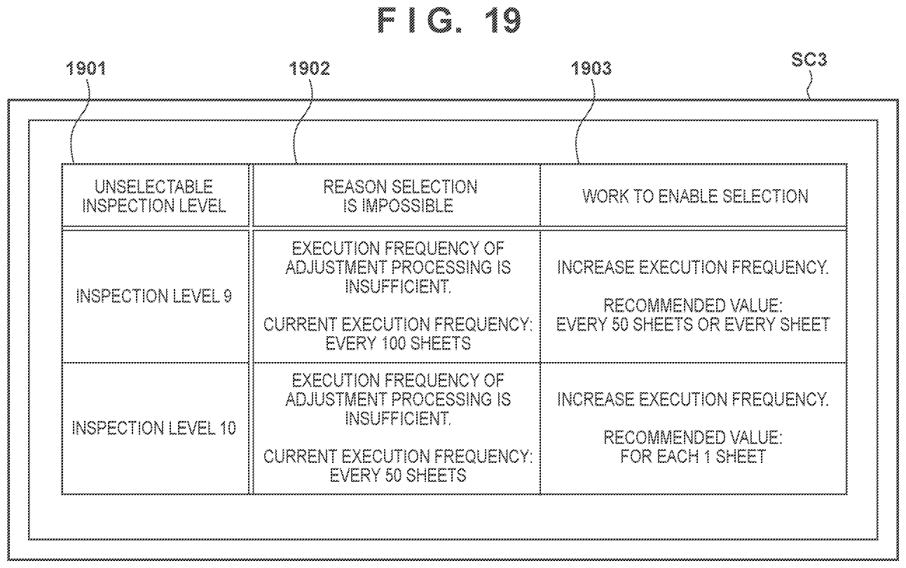

FIG. 19 illustrates a details screen SC3 displayed when the button 706 is pressed. The details screen SC3 may be displayed with the list 703a. The screen generation unit 505 generates the details screen SC3 based on the unselectable inspection levels determined by the level determination unit 504, and displays the details screen in the display device 521. The details screen SC3 may be implemented as a pop-up window, for example.

A box 1901 indicates the inspection level determined to be unselectable. In this example, it is assumed that the image forming apparatus 30 is a printer engine A, and inspection levels 9 and 10 have been determined to be unselectable.

A box 1902 indicates the reason why the corresponding inspection level is unselectable. The execution frequency of the adjustment processing being insufficient for the inspection level is indicated here as an example of the reason.

A box 1903 indicates the details of an operation required to make the corresponding inspection level selectable. In this example, a suggestion to increase the execution interval is given. Note that a recommended value for the execution interval for each inspection level may be displayed.

(15) Technical Spirit Derived from Embodiments

### (Item 1)

The image forming apparatus 30 is an example of a printing unit that prints an image onto a sheet P. The CPUs 201 and 501 and the obtainment unit 503 are examples of a controller that obtain an execution frequency (adjustment setting) of the adjustment processing executed to maintain printing capabilities. The CPUs 201 and 501 and the level determination unit 504 function as a controller that, based on the execution frequency, determines a plurality of inspection levels that can be applied to inspection. The CPUs 201 and 501 and the selection unit 506 are examples of a controller that selects one inspection level among the plurality of inspection levels determined. The inspection apparatus 50 and the like are an example of a controller that inspects a print result by applying the one inspection level selected.

If an inspection level (passing criteria/failing criteria) exceeding the printing capabilities of the image forming apparatus 30 is set by the user, the number of failing products will increase, which reduces the usability. In particular, if the execution frequency of the adjustment processing for maintaining the printing capabilities is insufficient for the inspection level, the number of failing products may increase. According to Item 1, options for the inspection level are determined according to the execution frequency. It is therefore easy for the user to select an inspection level that fits the execution frequency. This reduces the number of failing products and improves the usability for inspections. An increase in the number of sheets determined to have failed is also suppressed.

### (Item 2)

The display device 21 and the display device 521 function as a display that displays the plurality of inspection levels (options) determined. The input device 22 and the input device 522 are an example of an input device that accepts an input indicating that one inspection level is selected from the plurality of inspection levels displayed.

### (Item 3)

The display device 21 and the display device 521 display a list (the list 703a) including N inspection levels. At this time, the display device 21 and the display device 521 may execute the display so as to distinguish between M inspection levels that are selectable (e.g., inspection levels 1 to 8) and N-M inspection levels that are unselectable (e.g., inspection levels 9 and 10). This makes it possible for the user to visually understand the selectable inspection levels and the unselectable inspection levels. N and M are integers.

### (Item 4)

The display device 21 and the display device 521 may gray out the N-M inspection levels that are unselectable. The grayed-out inspection levels cannot be selected by the user. As a result, the user can be made aware of the existence of unselectable inspection levels, while also actually being unable to select those inspection levels.

### (Item 5)

The list 703a may be displayed as a drop-down list. This enables the user to easily recognize the inspection level options.

### (Item 6)

As illustrated in FIGS. 11A to 11F, the display device 21 and the display device 521 may display a reason why the N-M inspection levels that are unselectable are unselectable. This enables the user to easily understand why a specific inspection level is unselectable.

### (Item 7)

As illustrated in FIGS. 11A to 11F, the reason may include that the execution frequency is insufficient (the execution interval is too long). This enables the user to select a higher inspection level by increasing the execution frequency.

### (Item 8)

As illustrated in FIGS. 11A to 11F, the display device 21 and the display device 521 may display details of an operation required to make the unselectable N-M inspection levels selectable. The user may desire a higher inspection level. By performing the displayed details of the operation, such a user can set a higher inspection level in the inspection apparatus 50.

### (Item 9)

As illustrated in FIGS. 11A to 11F, the details of the operation may include a message prompting the execution frequency to be increased. This enables the user to increase the execution frequency and select a higher inspection level.

### (Item 10)

The memories 210 and 510 function as a memory that stores a relationship between the execution frequency of the adjustment processing and the applicable inspection level. The CPUs 201 and 501 may determine the plurality of inspection levels corresponding to execution frequencies based on the relationships stored in the memory. According to FIG. 12, an inspection level that is directly on a line indicating an upper limit value for the inspection level, or is below the line, is an inspection level that is selectable. An inspection level that is above the line indicating the upper limit value is an inspection level that is unselectable.

### (Item 11)

The memories 210 and 510 may function as a memory that stores a relationship between the execution frequency of the adjustment processing and the upper limit value of the inspection level. According to FIG. 12, the level determination unit 504 may determine the upper limit value corresponding to the execution frequency based on the relationship stored in the memory, and determine the plurality of inspection levels to be no greater than the upper limit value.

### (Item 12)

The plurality of inspection levels may be associated with passing criteria or failing criteria for the print result. For example, the inspection level may be associated with a permissible range of color shift amounts or the like. The inspection level may be associated with a permissible range of tint variation amounts. The inspection level may be associated with a permissible number or surface area of black spots. The inspection level may be associated with a permissible thickness, length, or surface area of a streak image.

### (Items 13 and 14)

The display device 521 and the input device 522 may be provided in the host computer 90 that instructs the printing unit to print. As illustrated in FIG. 1, the operation unit 20 including the display device 21 and the input device 22 may be attached to a housing of the printing unit.

### (Item 15)

The stacking apparatuses 60a to 60c are an example of stacking trays in which sheets for which the print result is determined to be a failure are stacked.

(Item 16) When a print result is determined to be a failure, the image forming apparatus 30 may reprint the image on another sheet (recovery processing). This improves the usability with respect to reprinting.

### (Item 17)

The plurality of inspection levels may be levels which require a higher printing accuracy as the numerical value of the level increases. For example, the printing accuracy required at inspection level 10 is higher than the printing accuracy required at inspection level 9. Note that the plurality of inspection levels may instead be levels which require a higher printing accuracy as the numerical value of the level decreases.

### (Item 18)

The printer engine 1830 is an example of a plurality of image forming units that form an image on a carrier using a plurality of toners of different colors. The light sensor 18 functions as an image sensor or image reader that detects a test image formed on the carrier for each different color. The adjustment processing unit 207 functions as a processor that executes adjustment processing for image forming conditions for each different color based on the result of detecting the test image (adjustment image). The counter 1802 may function as a counter that counts the number of sheets P on which an image has been formed and resets the count value 1812 at which the adjustment processing is executed. The adjustment setting unit 208 functions as a setting processor that sets the execution frequency of the adjustment processing. The adjustment processing unit 207 executes the adjustment processing when the count value 1812 reaches a value corresponding to the execution frequency.

### (Item 19)

As described with reference to FIG. 9, the test image may include a test pattern for detecting an amount of misalignment between the positions at which the images of each color are formed. The test image may include a test pattern for detecting tint variations in the image. The test image may include a test pattern for detecting the presence or absence of an unexpected image formed on the sheet.

### (Item 20)

The inspection apparatus 50 may inspect one or more of misalignment in the position at which the image is formed, color shift in the image, tint variations in the image (a first inspection), or the presence or absence of an unexpected image formed on the sheet (e.g., black spots or a streak image) (a second inspection), in the print result. The controller need not limit the upper limit value of the inspection level applied in the second inspection, and may limit the upper limit value of the inspection level applied in the first inspection based on the execution frequency. Unexpected images such as black spots occur regardless of the execution frequency of the adjustment processing. As such, the user may be capable of freely setting the inspection level for black spots and the like.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-070970, filed Apr. 24, 2023 which is hereby incorporated by reference herein in its entirety.

What is claimed is:

1. An inspection apparatus that inspects an image formed on a sheet by an image forming apparatus, the inspection apparatus comprising:
an image sensor configured to read the image on the sheet; and
a controller configured to:
accept user selection information indicating an inspection level for an inspection item to be inspected in the image read by the image sensor;
obtain an adjustment setting pertaining to a frequency of executing adjustment processing in which the image forming apparatus forms an adjustment image, wherein based on a result of detecting the adjustment image, the image forming apparatus adjusts a quality of an image formed by the image forming apparatus;
execute inspection at the inspection level indicated by the user selection information, in a case where a first adjustment setting is obtained; and
execute inspection at an inspection level lower than or equal to a predetermined inspection level, and not execute inspection at an inspection level higher than the predetermined inspection level, in a case a second adjustment setting in which the frequency is lower than in the first adjustment setting is obtained.

2. The inspection apparatus according to claim 1, further comprising:
a display configured to display the inspection level for the inspection item to be selectable from a plurality of inspection levels,
wherein when the second adjustment setting is obtained, the display does not display the inspection level higher than the predetermined inspection level.

3. The inspection apparatus according to claim 1, further comprising:
a display configured to display the inspection level for the inspection item to be selectable from a plurality of inspection levels,
wherein when the second adjustment setting is obtained, the display displays the inspection level higher than the predetermined inspection level to be unselectable.

4. The inspection apparatus according to claim 3,
wherein when the second adjustment setting is obtained, the display grays out the inspection level higher than the predetermined inspection level.

5. The inspection apparatus according to claim 1, further comprising:
a display configured to display the inspection level for the inspection item to be selectable from a plurality of inspection levels,
wherein when the second adjustment setting is obtained, if the inspection level higher than the predetermined inspection level is selected, the display displays a message prompting the inspection level for the inspection item to be changed.

6. The inspection apparatus according to claim 1,
wherein the inspection item includes a first inspection item and a second inspection item,
when the first adjustment setting is obtained, the first inspection item is inspected at the inspection level indicated by the user selection information,
when the second adjustment setting is obtained, the first inspection item is inspected at an inspection level lower than or equal to the predetermined inspection level, and the first inspection item is not inspected at an inspection level higher than the predetermined inspection level, and
the second inspection item is inspected at the inspection level indicated by the user selection information regardless of the adjustment setting.

7. The inspection apparatus according to claim 6,
wherein the controller is configured to obtain a reference image to be compared with the image read by the image sensor, and
the first inspection item is misalignment between the reference image and the image read by the image sensor.

8. The inspection apparatus according to claim 6,
wherein the controller is configured to obtain a reference image to be compared with the image read by the image sensor, and
the first inspection item is a difference in tint between the reference image and the image read by the image sensor.

9. The inspection apparatus according to claim 6,
wherein the second inspection item is a black spot appearing in the image read by the image sensor.

10. The inspection apparatus according to claim 1,
wherein the adjustment processing is processing for adjusting an image forming condition of the image forming apparatus that affects a result of inspecting the inspection item.

11. The inspection apparatus according to claim 1,
wherein the adjustment setting is information on a number of sheets on which the image forming apparatus has formed an image.

12. A method for controlling an image forming system, the image forming system comprising an image forming apparatus that forms an image on a sheet, a reading apparatus that reads the image formed on the sheet by the image forming apparatus, and an inspection apparatus that inspects the image read by the reading apparatus, the method comprising:
accepting user selection information indicating an inspection level for an inspection item;
obtaining an adjustment setting pertaining to a frequency of executing adjustment processing in which the image forming apparatus forms an adjustment image, wherein based on a result of detecting the adjustment image, the image forming apparatus adjusts a quality of an image formed by the image forming apparatus;
executing inspection at the inspection level indicated by the user selection information, in a case where a first adjustment setting is obtained; and
executing inspection at an inspection level lower than or equal to a predetermined inspection level, and not executing inspection at an inspection level higher than the predetermined inspection level, in a case a second adjustment setting in which the frequency is lower than in the first adjustment setting is obtained.

13. The method according to claim 12, further comprising:
causing a display to display the inspection level for the inspection item to be selectable from a plurality of inspection levels,
wherein when the second adjustment setting is obtained, the inspection level higher than the predetermined inspection level is not displayed in the display.

14. The method according to claim 12, further comprising:
causing a display to display the inspection level for the inspection item to be selectable from a plurality of inspection levels,
wherein when the second adjustment setting is obtained, the inspection level higher than the predetermined inspection level is displayed in the display to be unselectable.

15. The method according to claim 14,
wherein when the second adjustment setting is obtained, the inspection level higher than the predetermined inspection level is grayed out in the display.

16. The method according to claim 12, further comprising:
causing a display to display the inspection level for the inspection item to be selectable from a plurality of inspection levels,
wherein when the second adjustment setting is obtained, if the inspection level higher than the predetermined inspection level is selected, a message prompting the inspection level for the inspection item to be changed is displayed in the display.

17. The method according to claim 12,
wherein the inspection item includes a first inspection item and a second inspection item,
when the first adjustment setting is obtained, the first inspection item is inspected at the inspection level indicated by the user selection information,
when the second adjustment setting is obtained, the first inspection item is inspected at an inspection level lower than or equal to the predetermined inspection level, and the first inspection item is not inspected at an inspection level higher than the predetermined inspection level, and
the second inspection item is inspected at the inspection level indicated by the user selection information regardless of the adjustment setting.

18. The method according to claim 17, further comprising:
obtaining a reference image to be compared with the image read by the reading apparatus,
wherein the first inspection item is misalignment between the reference image and the image read by the reading apparatus.

19. The method according to claim 17, further comprising:
obtaining a reference image to be compared with the image read by the reading apparatus,
wherein the first inspection item is a difference in tint between the reference image and the image read by the reading apparatus.

20. The method according to claim 17,
wherein the second inspection item is a black spot appearing in the image read by the reading apparatus.

21. The method according to claim 12,
wherein the adjustment processing is processing for adjusting an image forming condition of the image forming apparatus that affects a result of inspecting the inspection item.

22. The method according to claim 12,
wherein the adjustment setting is information on a number of sheets on which the image forming apparatus has formed an image.
